(19) United States
(12) Patent Application Publication
(10) Pub. No.: US 2025/0264706 A1
(43) Pub. Date: Aug. 21, 2025

(54) CONVERSION METHOD, OPTICAL DEVICE, AND OPTICAL MICROSCOPE

(71) Applicant: NIKON CORPORATION, Tokyo (JP)

(72) Inventors: Fumihiro DAKE, Tokyo (JP); Hitoshi KAWAI, Tokyo (JP)

(73) Assignee: NIKON CORPORATION, Tokyo (JP)

(21) Appl. No.: 19/084,030

(22) Filed: Mar. 19, 2025

Related U.S. Application Data
(63) Continuation of application No. PCT/JP2022/035205, filed on Sep. 21, 2022.

(51) Int. Cl. G02B 21/00

(52) U.S. Cl. CPC G02B 21/0076; G02B 21/0032

(57) ABSTRACT

A conversion method includes converting a repetition frequency of pulsed light emitted from a light source by a converter, and allowing the repetition frequency converted by the converter to be variable.

### TECHNICAL FIELD

The present invention relates to a conversion method, an optical device, and an optical microscope.

### BACKGROUND ART

Pulsed light may be used as the laser light emitted from an optical microscope to a sample (refer to Patent Literature 1). Patent Literature 1 discloses emitting pulsed light of a high repetition frequency to a sample and reducing the peak intensity of the pulsed light to suppress photobleaching while maintaining the signal intensity acquired when pulsed light of a low repetition frequency is emitted at the sample. From a practical standpoint, a higher repetition frequency of pulsed light is not always advantageous.

### CITATION LIST

### Patent Literature

[Patent Literature 1] U.S. Pat. No. 7,961,764, Specification

### SUMMARY OF INVENTION

According to a first aspect of the present invention, there is provided a conversion method including converting a repetition frequency of pulsed light emitted from a light source by a converter and allowing the repetition frequency converted by the converter to be variable.

According to a second aspect of the present invention, there is provided an optical device including a converter that converts a repetition frequency of a pulsed light, and a switcher capable of changing the repetition frequency converted by the converter.

According to a third aspect of the present invention, there is provided a microscope that emits the pulsed light to an observation object, the microscope including an optical device that converts the repetition frequency of the pulsed light and is capable of changing the repetition frequency converted by the converter, and a light emitter that emits the pulsed light, output from the optical device, to an observation object.

### BRIEF DESCRIPTION OF THE DRAWINGS

FIG. 1 is a diagram showing a configuration example of a microscope according to a first embodiment.

FIG. 2 is a diagram showing a configuration example of an optical device according to the first embodiment.

FIGS. 3A and 3B are diagrams for describing a case according to the first embodiment, where the repetition frequency is changed by a factor of 1.

FIGS. 4A and 4B are diagrams for describing a case according to the first embodiment, where the repetition frequency is changed by a factor of 2.

FIGS. 5A and 5B are diagrams for describing a case according to the first embodiment, where the repetition frequency is changed by a factor of 4.

FIGS. 6A, 6B, and 6C are diagrams showing the relationship between polarization of pulsed light shown in FIGS. 5A and 5B and the angle with the optical axis of a half-wave plate.

FIG. 7 is a schematic diagram of time intervals and polarization of incident light and emitted light in a pulse converter shown in FIGS. 5A and 5B.

FIGS. 8A and 8B are diagram for describing a case according to the first embodiment, where the repetition frequency is changed by a factor of 8.

FIGS. 9A, 9B, and 9C are diagrams showing the relationship between polarization of pulsed light and the angle with the optical axis of a half-wave plate, according to the first embodiment.

FIG. 10 is a schematic diagram of time intervals and polarization of incident light and emitted light in the pulse converter according to the first embodiment.

FIG. 11 is a diagram for describing a flow of a conversion method according to the first embodiment.

FIG. 12 is a diagram showing a modified example of the optical device according to the first embodiment.

FIG. 13 is a schematic diagram of time intervals and polarization of incident light and emitted light in the optical device of the modified example shown in FIG. 12.

FIG. 14 is a diagram showing a configuration example of an optical device according to a second embodiment.

FIG. 15 is a diagram showing a configuration example of an optical device according to a third embodiment.

FIG. 16 is a diagram showing a configuration example of an optical device according to a fourth embodiment.

FIG. 17 is a diagram showing a configuration example of the optical device according to the fourth embodiment.

FIG. 18 is a diagram showing a configuration example of an optical device according to a fifth embodiment.

FIG. 19 is a diagram for describing an optical path in a pulse converter according to the fifth embodiment.

FIG. 20 is a diagram for describing an optical path in the pulse converter according to the fifth embodiment.

FIG. 21 is a diagram for describing an optical path in the pulse converter according to the fifth embodiment.

FIGS. 22A to 22H are diagrams showing the state of the optical path in the pulse converter according to the fifth embodiment.

FIG. 23 is a diagram showing a modified example of an optical unit in the optical device according to the fifth embodiment.

### DESCRIPTION OF EMBODIMENTS

Hereinafter, the present invention will be described through embodiments of the invention. However, the invention defined in the claims is not limited to the following embodiments, and not all combinations of features described in the embodiments are essential to the means by which the present invention solves the above problems. In the drawings, the same or similar members are denoted by the same reference signs, and redundant descriptions may be omitted. The shape and size of the elements in the drawings may be exaggerated for the purpose of clearer description.

### First Embodiment

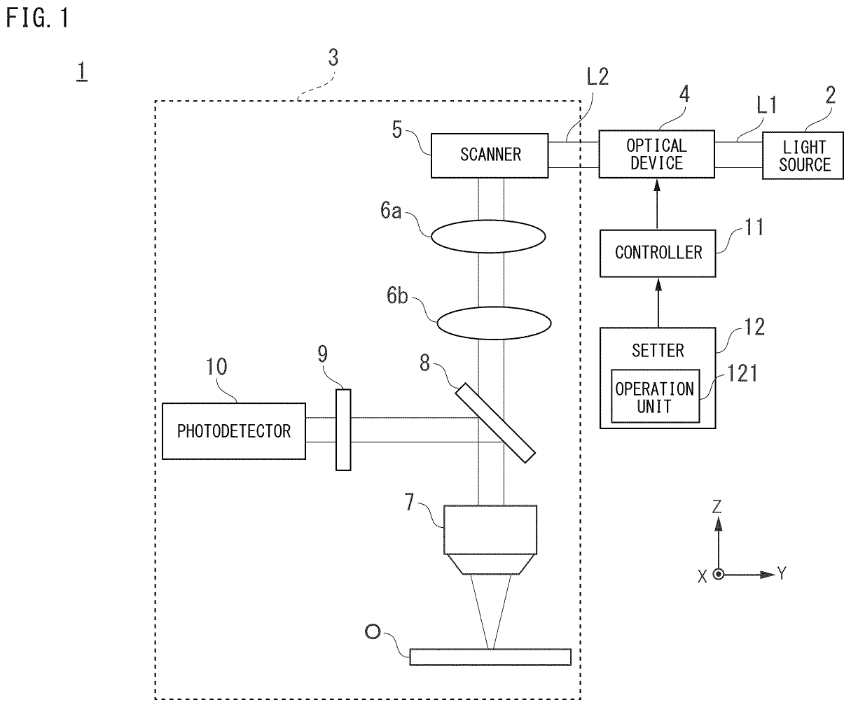

FIG. 1 is a diagram showing a configuration example of a microscope 1 according to a first embodiment. In FIG. 1, an example is shown where the microscope 1 is a multiphoton fluorescence microscope. However, the microscope 1 is not limited to being a multiphoton fluorescence microscope and may be a microscope other than a multiphoton fluorescence microscope. In the following, as an example of the embodiment, the microscope 1 is described using two-photon fluorescence as an example of a nonlinear phenomenon. However, the application to other microscopic observation techniques employing pulsed light as a light source is also possible, whether they are linear or nonlinear. For example, the microscope 1 may be a three-photon fluorescence microscope that uses fluorescence resulting from three-photon absorption. The microscope 1 may be a CARS (Coherent anti-Stokes Raman Scattering) microscope or an SRS (Stimulated Raman Scattering) microscope that employs nonlinear Raman scattering. The microscope 1 may also be a pump-probe microscope that employs stimulated emission or transient absorption. The microscope 1 may also be a photoacoustic microscope that employs the photoacoustic effect.

The microscope 1 according to the first embodiment includes, for example, a light source 2, a light emitter 3, an optical device 4, a controller 11, and a setter 12. However, the controller 11 and the setter 12 are not essential components for the microscope 1. In other words, the microscope 1 may not include the controller 11 and the setter 12.

The light source 2 outputs pulsed light (also referred to as pulsed laser light) L1 having a repetition frequency fr, a repetition period Tr, and a wavelength range of 700 nm to 1300 nm (near-infrared), exhibiting linear polarization. For example, the light source 2 may be a femtosecond pulsed laser (pulse width: 50 to 100 fs) or a picosecond pulsed laser. The pulsed light L1 has a repetition frequency fr of approximately 80 MHZ. The light source 2 includes a solid-state light source (which may include an optical fiber) such as an LD (laser diode).

If the light source 2 is equipped with a dispersion compensation function, the dispersion compensation of the optical system may be implemented using the dispersion compensation function of the light source 2. If the light source 2 is not equipped with a dispersion compensation function, it is preferable that a separate dispersion compensation optical system be provided between the light source 2 and the optical device 4. The dispersion compensation optical system is, for example, a prism pair or a diffraction grating pair. The optical elements other than the dispersion compensation optical system may also be arranged.

The repetition frequency of the pulsed light L1 output from the light source 2 is changed by the optical device 4. The pulsed light L1 the repetition frequency of which has been changed by the optical device 4 is referred to as pulsed light L2. The polarization of pulsed light L2 is linear. The pulsed light L2 is incident on the light emitter 3. Even in those cases where the repetition frequencies of the pulsed light L1 and the pulsed light L2 are the same, it is described that the repetition frequency is converted by a factor of 1 and emitted from the optical device 4 as pulsed light L2, and this is included in the concept of converting the repetition frequency.

The light emitter 3 emits the pulsed light L2, output from the optical device 4, to an observation object O. The light emitter 3 includes, for example, a scanner 5, a scan lens 6a, a tube lens 6b, an objective lens 7, a dichroic mirror 8, a filter 9, and a photodetector 10.

The scanner 5 is a mechanism that oscillates the pulsed light L2 in a plane perpendicular to the optical axis of the light emitter 3, that is, in the XY direction as shown in the figure. The scanner 5, as an example, has a pair of mirrors (galvanometer mirrors) for the X-axis direction and the Y-axis direction. The pulsed light L2 is reflected by the pair of galvanometer mirrors and deflected in the X-axis and Y-axis directions relative to the optical axis of the light emitter 3, thereby scanning the observation object O in the XY direction. The pair of mirrors are positioned near the conjugate position relative to the pupil of the objective lens 7. The scanner 5 may be a combination of a galvanometer mirror and a resonant mirror.

The scan lens 6a and the tube lens 6b are provided in the subsequent stage of the scanner 5. The scan lens 6a focuses the pulsed light L2 emitted from the scanner 5 onto the primary image plane. The tube lens 6b is arranged between the scan lens 6a and the objective lens 7. The tube lens 6b collimates pulsed light L2 into a parallel light beam. The pulsed light L2 from the tube lens 6b is incident on the dichroic mirror 8.

The dichroic mirror 8 transmits the pulsed light L2. The pulsed light L2 transmitted through the dichroic mirror 8 is incident on the objective lens 7. The dichroic mirror 8 reflects light of wavelengths other than those of the pulsed light L2.

The objective lens 7 focuses the pulsed light L2, serving as excitation light, to illuminate the observation object O. In other words, the pulsed light L2, serving as excitation light, is focused onto the objective lens 0 through the objective lens 7, inducing two-photon excitation. The fluorescence resulting from the observation object O passes through the objective lens 7, is reflected by the dichroic mirror 8, and is separated in optical path from the pulsed light L2.

The filter 9 is provided in the optical path between the dichroic mirror 8 and the photodetector 10. The filter 9 transmits only the fluorescence wavelength component of the light reflected by the dichroic mirror 8.

The photodetector 10 detects the light transmitted through the filter 9. In other words, the photodetector 10 detects the fluorescence that has been reflected by the dichroic mirror 8 and transmitted through the filter 9. For example, the photodetector 10 is a photomultiplier tube. The detection signal, corresponding to the amount of fluorescence light detected by photodetector 10, is output to an information processor, such as a computer (not shown in the drawings), for example. The information processor generates a two-dimensional image or a three-dimensional image of the observation object O based on the detection signal.

The light emitter 3 may have a configuration for confocal fluorescence detection. In such a case, the dichroic mirror 8 is placed not near the objective lens 7, but in the preceding stage of the scanner 5. The light reflected by the dichroic mirror 8 passes through the filter 9 and is focused on a pinhole by a newly provided lens (not shown in the drawings). The fluorescence transmitted through the pinhole is detected by the photodetector 10 installed in the subsequent stage.

The optical device 4 is capable of converting the repetition frequency fr of pulsed light L1 emitted from the light source 2 to a repetition frequency different from the repetition frequency fr. For example, the optical device 4 converts the repetition frequency fr by a maximum factor of 2ⁿ (where n is an integer greater than or equal to one). The optical device 4 splits the pulsed light into first polarized light and second polarized light orthogonal to the first polarized light, imparts a predetermined optical-path-length difference between the first polarized light and the second polarized light, and then combines the first polarized light and the second polarized light after imparting the optical-path-length difference. This series of processes is performed n iterations (where n is an integer from 1 through n), thereby converting the repetition frequency by a factor of 2ⁿ. The first polarized light is, for example, P-polarized light. The second polarized light is, for example, S-polarized light. The optical device 4 may be configured to be removably inserted in the microscope 1.

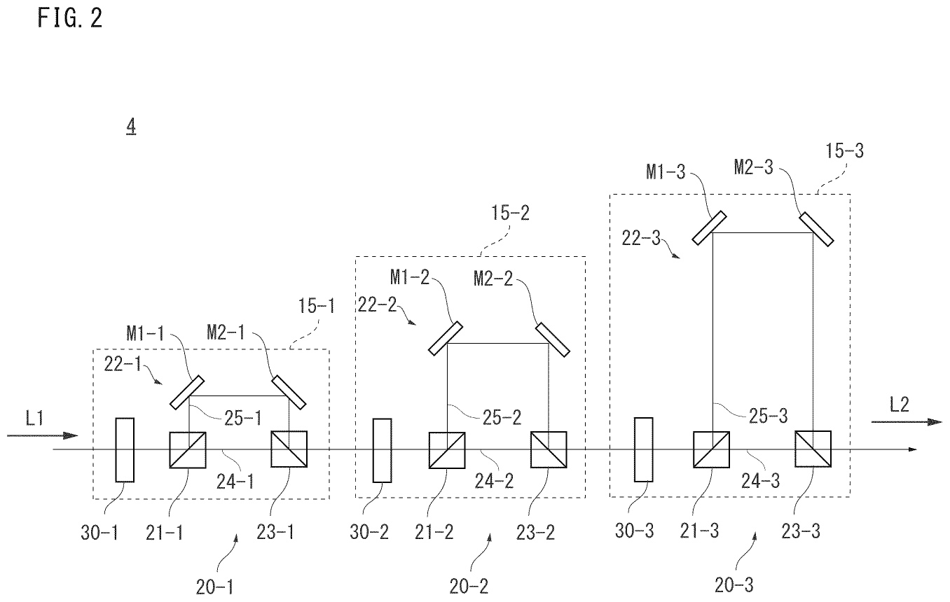

FIG. 2 is a diagram showing a configuration example of the optical device 4 according to the first embodiment. The optical device 4 includes, for example, n units of pulse converters 15. The optical device 4 exemplified in FIG. 2 includes three pulse converters 15-1 through 15-3. The reference signs following the hyphen serve to distinguish multiple components of the same type from one another. When multiple configurations of the same type are not to be distinguished from one another, the reference signs following the hyphen may be omitted.

The pulse converter 15 includes an optical unit 20 and a half-wave plate 30. The optical unit 20 is an example of a converter. The half-wave plate 30 is an example of a switcher. The optical unit 20 includes a first polarizing beam splitter 21, an optical-path-length-difference imparter 22, and a second polarizing beam splitter 23.

The first polarizing beam splitter 21 splits the pulsed light polarized in a first direction into first polarized light (P-polarized light) and second polarized light (S-polarized light). In other words, when the incident pulsed light is polarized in the first direction, the first polarizing beam splitter 21 transmits the first polarized light component of the pulsed light and reflects the second polarized light component of the pulsed light in a predetermined direction. The following describes an example where the first polarized light is P-polarized light and the second polarized light is S-polarized light.

The first direction is, for example, 45°. This 45° refers to a direction rotated counterclockwise by 45° from a direction orthogonal to the direction in which the pulsed light travels (for example, the horizontal direction). On the other hand, the first direction may be −45°, in which the components of the P-polarized light and the S-polarized light are contained in a ratio of 1:1. In other words, due to the rotational symmetry, the first direction may also be) 135° (−225°), 225° (−135°), or 315° (−45°. That is to say, as an example, in the case where linearly polarized light at an angle of 45° is incident on the first polarizing beam splitter 21, the P-polarized light component is transmitted and the S-polarized light component is reflected. Since the magnitudes of the P-polarized light component and the S-polarized light component in the 45° linearly polarized light are equal, the splitting ratio at the first polarizing beam splitter 21 is 1:1.

The optical-path-length-difference imparter 22 imparts an optical-path-length difference between the P-polarized light and the S-polarized light split by the first polarizing beam splitter 21. For example, the optical-path-length-difference imparter 22 includes a first optical path 24 and a second optical path 25.

The first optical path 24 is a path through which the P-polarized light transmitted through the first polarizing beam splitter 21 propagates until it reaches the second polarizing beam splitter 23. For example, of the pulsed light polarized in the first direction, the P-polarized light split by the first polarizing beam splitter 21 propagates along the first optical path 24 and is incident on the second polarizing beam splitter 23. In the case where the pulsed light polarized in a second direction is P-polarized light, it propagates along the first optical path 24 and is incident on the second polarizing beam splitter 23. In the case where the pulsed light polarized in the second direction is S-polarized light, it propagates along the second optical path 25 and is incident on the second polarizing beam splitter 23.

The second optical path 25 is a path through which the S-polarized light reflected by the first polarizing beam splitter 21 propagates until it reaches the second polarizing beam splitter 23. For example, in the second optical path 25, a mirror M1 and a mirror M2 are provided. The S-polarized light split by the first polarizing beam splitter 21 is reflected by the mirror M1 and the mirror M2 and is incident on the second polarizing beam splitter 23. Here, the optical path length of the second optical path 25 is longer than the optical path length of the first optical path 24. Therefore, the optical-path-length-difference imparter 22 can impart the optical-path-length difference between the P-polarized light and the S-polarized light.

The second polarizing beam splitter 23 forms pulsed light the repetition frequency of which is changed by combining the P-polarized light and the S-polarized light after an optical-path-length difference is imparted by the optical-path-length-difference imparter 22. Since an optical-path-length difference is imparted between the P-polarized light and the S-polarized light, a predetermined time difference is imparted between the P-polarized light, which is an example of the first polarized light, and the S-polarized light, which is an example of the second polarized light, as they propagate toward the second polarizing beam splitter 23. Therefore, in the case where the P-polarized light and the S-polarized light are coaxially combined by the second polarizing beam splitter 23, the repetition frequency of the combined pulsed light is higher than the repetition frequency of the pulsed light incident on the first polarizing beam splitter 21.

The optical-path-length-difference imparter 22-1 imparts a first optical-path-length difference between the P-polarized light and the S-polarized light split by the first polarizing beam splitter 21-1. This first optical-path-length difference imparts a time difference of (Tr/8) between the P-polarized light and the S-polarized light.

The optical-path-length-difference imparter 22-2 imparts a second optical-path-length difference between the P-polarized light and the S-polarized light split by the first polarizing beam splitter 21-2. The second optical-path-length difference is greater than the first optical-path-length difference. This second optical-path-length difference imparts a time difference of (Tr/4) between the P-polarized light and the S-polarized light.

The optical-path-length-difference imparter 22-3 imparts a third optical-path-length difference between the P-polarized light and the S-polarized light split by the first polarizing beam splitter 21-3. The third optical-path-length difference is greater than the second optical-path-length difference. This third optical-path-length difference imparts a time difference of (Tr/2) between the P-polarized light and the S-polarized light.

The angle setting of the half-wave plate 30 allows switching of whether or not to cause the optical unit 20 to change the repetition frequency of the pulsed light L1. For example, the repetition frequency fr of the pulsed light L1 can be changed to a value that is a power of 2 times the repetition frequency fr. In other words, the angle setting of the half-wave plate 30 allows the repetition frequency fr to be changed within a range from 1 time to 2ⁿ times the repetition frequency fr. In the configuration exemplified in FIG. 2, n=3, and therefore the half-wave plates 30-1 through 30-3 can change the repetition frequency fr of the pulsed light L1 emitted from the light source 2 to one of four repetition frequencies, namely, fr×1, fr×2, fr×4, and fr×8.

The half-wave plate 30 changes the polarization direction of the pulsed light incident on the first polarizing beam splitter 21 in each optical unit 20 to either the first direction or the second direction, which is different from the first direction. The half-wave plate 30 is provided on the optical path through which the pulsed light is incident on the first polarizing beam splitter 21.

More specifically, the half wave plate 30 is rotatable. Rotating the half-wave plate 30 changes the angle θ between the polarization direction of the pulsed light incident on the half-wave plate 30 and the optical axis (slow axis or fast axis) of the half-wave plate 30 (hereinafter referred to simply as “angle”). For ease of description, in the following, the slow axis of the half-wave plate 30 is referred to as the optical axis of the half-wave plate 30, and the polarization direction of the incident pulsed light is the lateral direction (horizontal direction, corresponding to P-polarized light) perpendicular to the direction in which the pulsed light travels. For example, rotating the half-wave plate 30 allows switching between a first state where the angle θ of the half-wave plate 30 is within a first angular range, and a second state where the angle θ of the half-wave plate 30 is within a second angular range. When the angle θ is within the first angular range, pulsed light polarized in the first direction is emitted from the half-wave plate 30.

When the angle θ is within the second angular range, different from the first angular range, the pulsed light in the second direction, different from the first direction, is emitted from the half-wave plate 30. The first angular range is a range of 22.5°±1°. As a result, the polarization of the pulsed light that has passed through the half-wave plate 30 is 45°. Due to the rotational symmetry of the polarization direction, the first angular range may also be 67.5°±1°. In such a case, the polarization of the pulsed light transmitted through the half-wave plate 30 is 135°. The polarization direction in such a case is equivalent to −45°. In the case where the polarization direction of the pulsed light is vertical (corresponding to S-polarized light), the first angular range of 22.5°±1° corresponds to 112.5°±1° or −67.5°±1° when expressed as the angle between the slow axis of the half-wave plate 30 and the polarization direction of the pulsed light. In other words, the first angular range is) (22.5°±K×45°±1° where K is an integer. The same is true when the slow axis of the half-wave plate 30 is replaced with the fast axis. The second angular range is a range of 0°±1°. Due to the rotational symmetry of the polarization direction of the pulsed light, this can be expressed as ±180°±1°. In the case where the polarization direction of the pulsed light is vertical (corresponding to S-polarized light), the second angular range of 0°±1° corresponds to 90°±1° or −270°±1° when expressed as the angle between the slow axis of the half-wave plate 30 and the polarization direction of the pulsed light. In other words, the second angular range is) (0°±K×90°±1° where K is an integer. The same is true when the slow axis of the half-wave plate 30 is replaced with the fast axis. The tolerance of the first angular range being ±1° is to ensure that the variation in intensity between pulses of pulsed light L2 after the repetition frequency is converted stays within a range of approximately ±15% of the average intensity of the pulsed light L2. The tolerance of the second angular range being ±1° is to ensure that the output of each of the multiple polarizing beam splitters does not decrease by more than 5% compared to the input.

The half-wave plate 30-1 is provided in the preceding stage of the first polarizing beam splitter 21-1. The half-wave plate 30-1 changes the polarization direction of the pulsed light incident on the first polarizing beam splitter 21-1 to either the first direction or the second direction, which is different from the first direction. The half-wave plate 30-2 is provided in the subsequent stage of the second polarizing beam splitter 23-1 and also in the preceding stage of the first polarizing beam splitter 21-2. The half-wave plate 30-2 changes the polarization direction of the pulsed light emitted from the second polarizing beam splitter 23-1 and incident on the first polarizing beam splitter 21-2 to either the first direction or the second direction, which is different from the first direction. The half-wave plate 30-3 is provided in the subsequent stage of the second polarizing beam splitter 23-2 and also in the preceding stage of the first polarizing beam splitter 21-3. The half-wave plate 30-3 changes the polarization direction of the pulsed light emitted from the second polarizing beam splitter 23-2 and incident on the first polarizing beam splitter 21-3 to either the first direction or the second direction, which is different from the first direction.

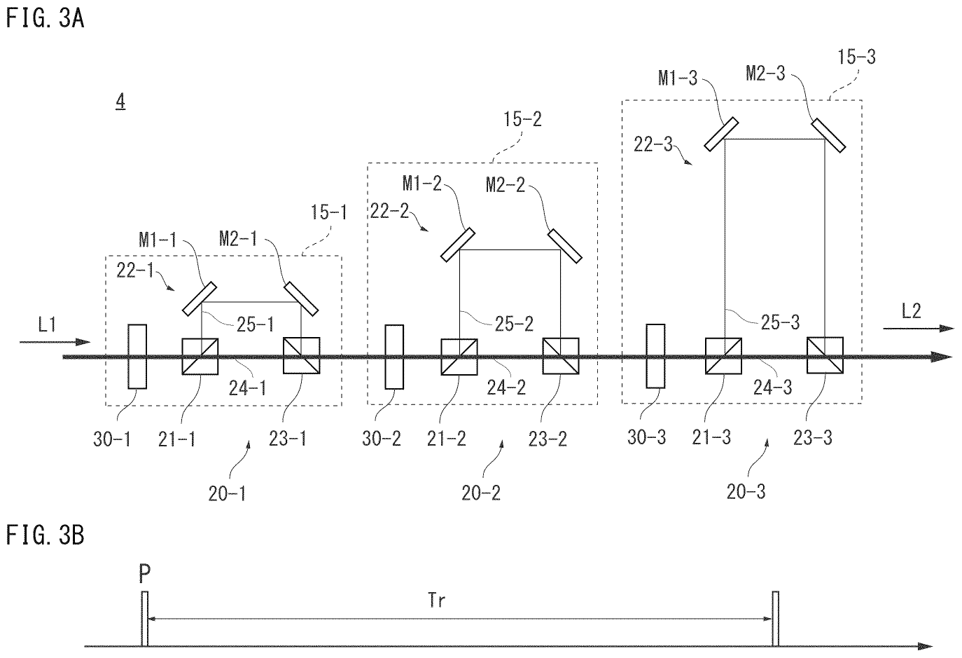

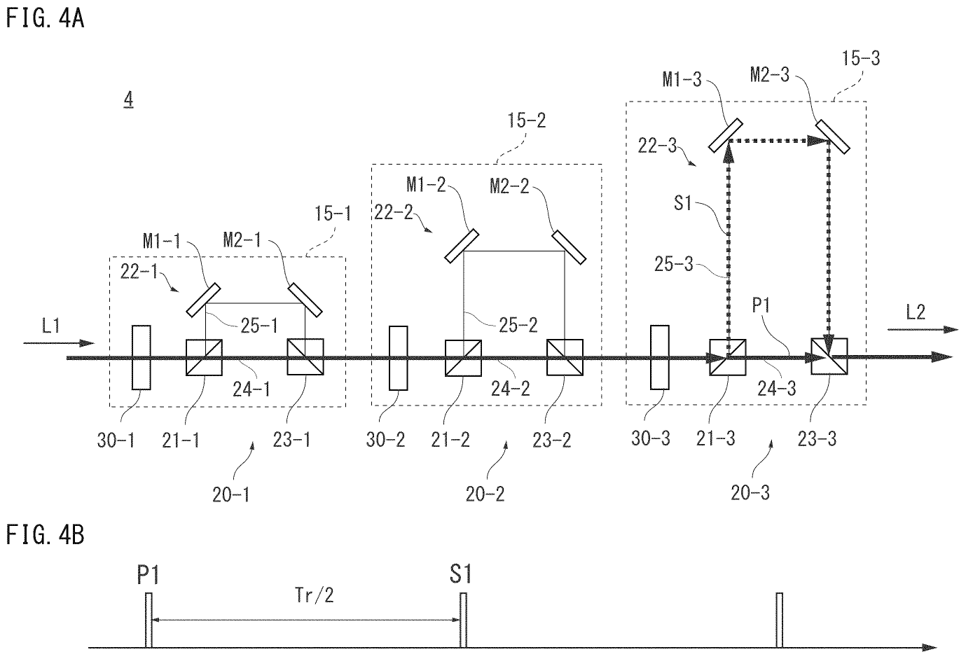

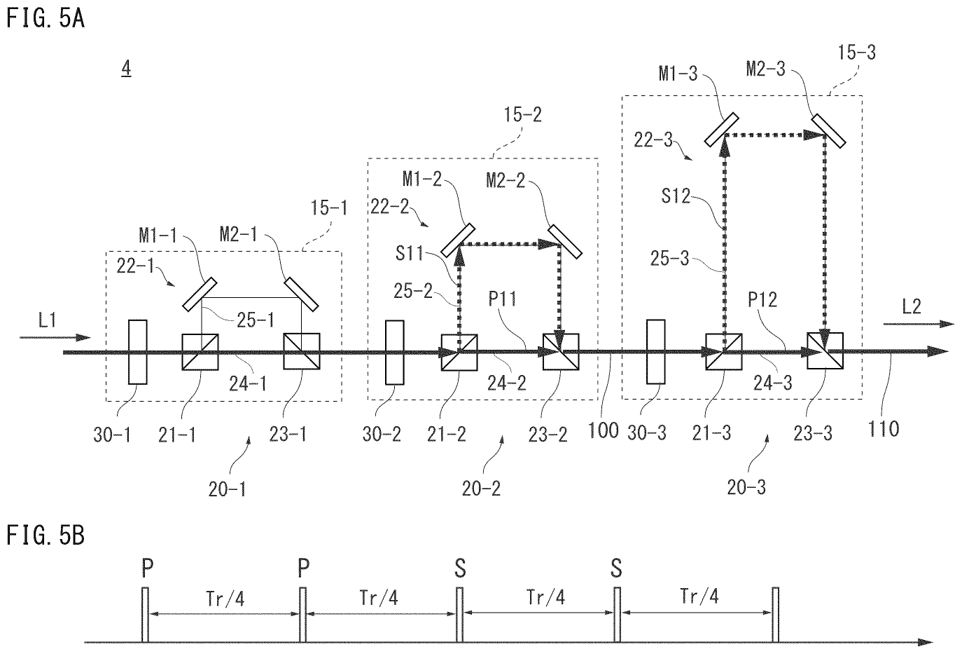

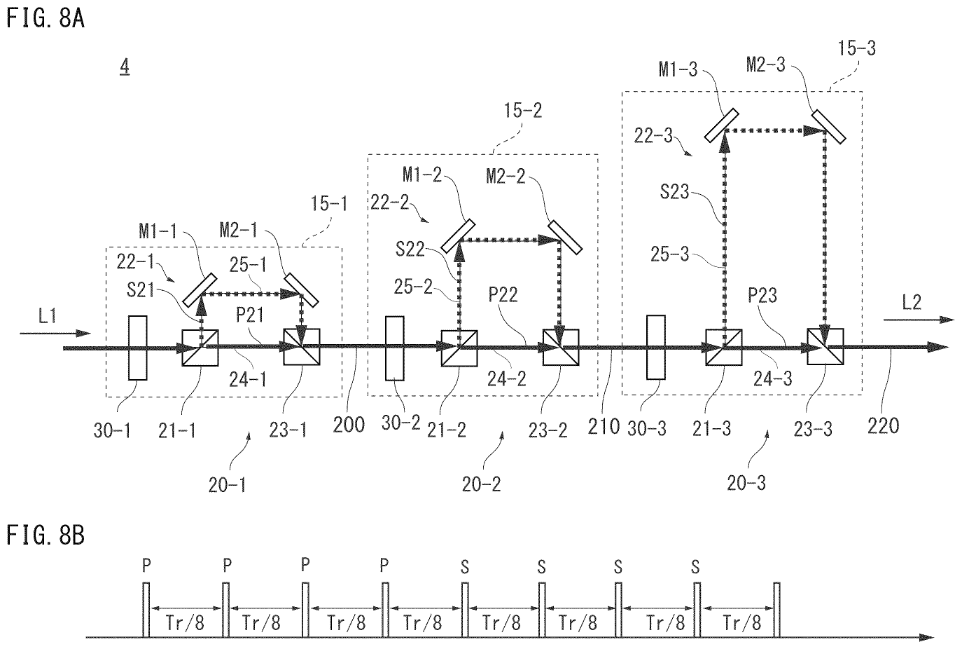

Hereunder, a method for varying a repetition frequency according to the first embodiment will be described. FIGS. 3A and 3B are diagrams for describing a case where the repetition frequency is changed to fr×1. FIGS. 4A and 4B are diagrams for describing a case where the repetition frequency is changed to fr×2. FIGS. 5A and 5B are diagrams for describing a case where the repetition frequency is changed to fr×4. FIGS. 8A and 8B are diagram for describing a case where the repetition frequency is changed to fr×8.

As shown in FIGS. 3A and 3B, when the repetition frequency fr of the pulsed light L1 incident on the optical device 4 is changed to fr×1, the angles θ of the half-wave plate 30-1, the half-wave plate 30-2, and the half-wave plate 30-3 are set within the second angular range. Therefore, as shown in FIG. 3A, the pulsed light L1 (P-polarized light) emitted from the light source 2 is transmitted through each of the first polarizing beam splitters 21-1 through 21-3 without being split. In other words, the optical units 20-1 through 20-3 do not cause light splitting or time delay impartation for the pulsed light L1, thus maintaining the repetition frequency fr of the pulsed light L1. In such a case, as shown in FIG. 3B, the pulsed light L1, with a pulse interval of Tr, is output from the optical device 4 as pulsed light L2.

Next, a method for converting a repetition frequency by a factor of 2 will be described. As shown in FIGS. 4A and 4B, when the repetition frequency fr of the pulsed light L1 incident on the optical device 4 is changed to fr×2, that is, changed by a factor of 21 (n=1), the angles θ of the half-wave plate 30-1 and the half-wave plate 30-2 are both set within the second angular range. On the other hand, the angle θ of the half-wave plate 30-3 is set to, for example, 22.5°. In such a case, the pulsed light L1 (P-polarized light) emitted from the light source 2 is transmitted through each of the first polarizing beam splitter 21-1 and the first polarizing beam splitter 21-2 without being split. In other words, the optical unit 20-1 and the optical unit 20-2 do not cause light splitting or time delay impartation, and the repetition frequency of the pulsed light emitted from the optical unit 20-1 and the optical unit 20-2 maintains the repetition frequency fr of the pulsed light L1 emitted from the light source 2. The polarization state of the pulsed light emitted from the optical unit 20-1 and the optical unit 20-2 remains P-polarized as with the pulsed light L1.

The pulsed light L1 output from the half-wave plate 30-3 shown in FIGS. 4A and 4B is linearly polarized at 45°. Therefore, as shown in FIGS. 4A, of the pulsed light (linearly polarized at) 45° output from the half-wave plate 30-3, the P-polarized light P1 is transmitted through the first polarizing beam splitter 21-3, while the S-polarized light S1 is reflected by the first polarizing beam splitter 21-3. The P-polarized light P1, having been transmitted through the first polarizing beam splitter 21-3, propagates along a first optical path 24-3 and is incident on the second polarizing beam splitter 23-3.

On the other hand, the S-polarized light S1, having been reflected by the first polarizing beam splitter 21-3, propagates along a second optical path 25-3 and is incident on the second polarizing beam splitter 23-3. Therefore, a time difference corresponding to a third optical path difference, that is, a time difference of Tr/2, is imparted between the P-polarized light P1 and the S-polarized light S1. The second polarizing beam splitter 23-3, by combining the incident P-polarized light P1 and the S-polarized light S2, generates pulsed light with a repetition frequency of (fr×2). This pulsed light with the repetition frequency of (fr×2) is output from the optical device 4 as pulsed light L2. That is to say, as shown in FIGS. 4B, pulsed light with a pulse interval of (Tr/2) is emitted from the optical device 4 as the pulsed light L2.

Next, a method for converting a repetition frequency by a factor of 4 will be described, with reference to FIGS. 5A and 5B through FIG. 7.

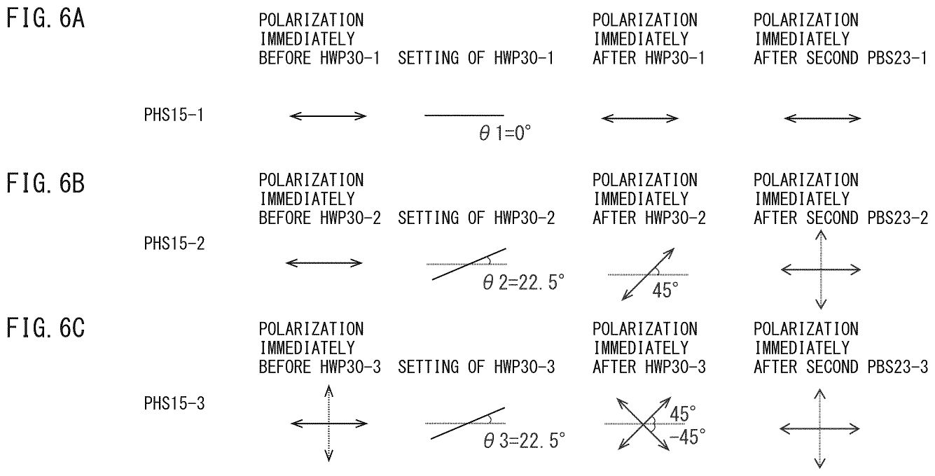

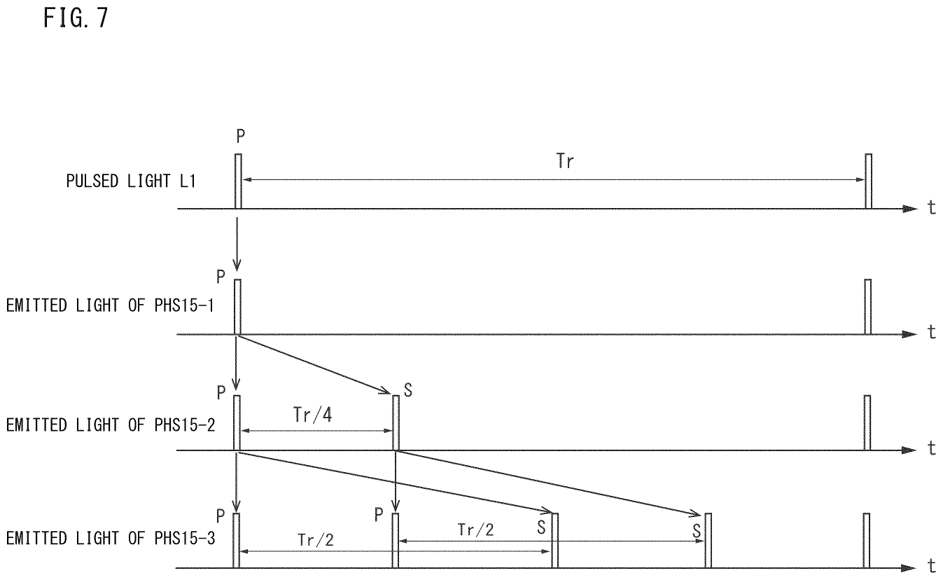

FIGS. 6A, 6B, and 6C are diagrams showing the relationship between polarization of pulsed light and the angle with the optical axis of a half-wave plate. FIGS. 6A, 6B, and 6C exemplify a case where the angle θ of the half-wave plate 30-1 is set within the second angular range (for example), 0°, and the angles θ of both the half-wave plate 30-2 and the half-wave plate 30-3 are set within the first angular range (for example), 22.5°. FIG. 6A shows the relationship between the polarization of the pulsed light incident on the optical unit 20-1, the polarization of the pulsed light emitted from the optical unit 20-1, and the angle θ of the half-wave plate 30-1. FIG. 6B shows the relationship between the polarization of the pulsed light incident on the optical unit 20-2, the polarization of the pulsed light emitted from the optical unit 20-2, and the angle θ of the half-wave plate 30-2. FIG. 6C shows the relationship between the polarization of the pulsed light incident on the optical unit 20-3, the polarization of the pulsed light emitted from the optical unit 20-3, and the angle θ of the half-wave plate 30-3. FIG. 7 is a schematic diagram of time intervals and polarization of incident light and emitted light in each pulse converter.

When the repetition frequency of the pulsed light L1 incident on the optical device 4 is changed to fr×4, that is, changed by a factor of 22 (n=2), the angle θ of the half-wave plate 30-1 is set within the second angular range. On the other hand, the angles θ of both the half-wave plate 30-2 and the half-wave plate 30-3 are set within the first angular range, for example, 22.5°. In such a case, as shown in FIG. 6A, the pulsed light L1 (P-polarized light) emitted from the light source 2 is transmitted through the first polarizing beam splitter 21-1 without being split. In other words, the optical unit 20-1 does not cause light splitting or time delay impartation, and the repetition frequency of the pulsed light emitted from the optical unit 20-1 maintains the repetition frequency fr of the pulsed light L1 emitted from the light source 2. The polarization state of the pulsed light emitted from the optical unit 20-1 remains P-polarized as with the pulsed light L1.

As shown in FIG. 6B, the pulsed light immediately after passing through the half-wave plate 30-2 becomes linearly polarized at 45°. Therefore, as shown in FIGS. 5A and 5B, of the pulsed light output from the half-wave plate 30-2, that is, of the 45° linearly polarized light, the P-polarized light P11 is transmitted through the first polarizing beam splitter 21-2, while the S-polarized light S11 is reflected by the first polarizing beam splitter 21-2. The P-polarized light P11, having been transmitted through the first polarizing beam splitter 21-2, propagates along a first optical path 24-2 and is incident on the second polarizing beam splitter 23-2. On the other hand, the S-polarized light S11, having been reflected by the first polarizing beam splitter 21-2, propagates along the second optical path 25-2 and is incident on the second polarizing beam splitter 23-2. Therefore, a time difference corresponding to a second optical path difference, that is, a time difference of Tr/4, is imparted between the P-polarized light P11 and the S-polarized light S11 (see FIG. 7). The second polarizing beam splitter 23-2, by combining the incident P-polarized light P11 and the S-polarized light S11, generates pulsed light 100. The pulsed light 100 generated by the second polarizing beam splitter 23-2 is incident on the optical unit 20-3.

The angle θ of the half-wave plate 30-3 is set within the first angular range, for example, 22.5° relative to the P-polarized light. Therefore, as shown in FIG. 6C, the polarization of the pulsed light 100 after passing through the half-wave plate 30-3 becomes linearly polarized at +45° and linearly polarized at −45°, respectively.

Of the temporally leading+45° linearly polarized light, the P-polarized light P12 is transmitted through the first polarizing beam splitter 21-3 and propagates along the first optical path 24-3. Of the +45° linearly polarized light, the S-polarized light S12 is reflected by the first polarizing beam splitter 21-3 and propagates along the second optical path 25-3. Of the −45° linearly polarized light, the P-polarized light P12 is transmitted through the first polarizing beam splitter 21-3 and propagates along the first optical path 24-3, while the S-polarized light S12 is reflected by the first polarizing beam splitter 21-3 and propagates along the second optical path 25-3. Consequently, a time difference of (Tr/2) is imparted between the P-polarized light P12 and the S-polarized light S12 (see FIG. 7). The second polarizing beam splitter 23-3, by combining the two incident P-polarized lights P12 and the two incident S-polarized lights S12, generates pulsed light 110 with a repetition frequency of (fr×4). That is to say, as shown in FIGS. 5B, the pulsed light P110 with a pulse interval of (Tr/4) is emitted from the optical device 4 as pulsed light L2.

Next, a method for converting a repetition frequency by a factor of 8 will be described, with reference to FIGS. 8A and 8B through FIG. 10.

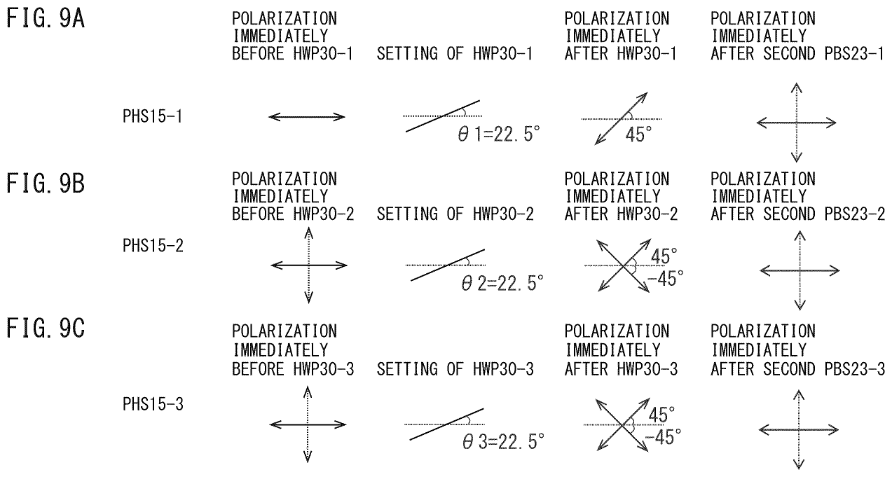

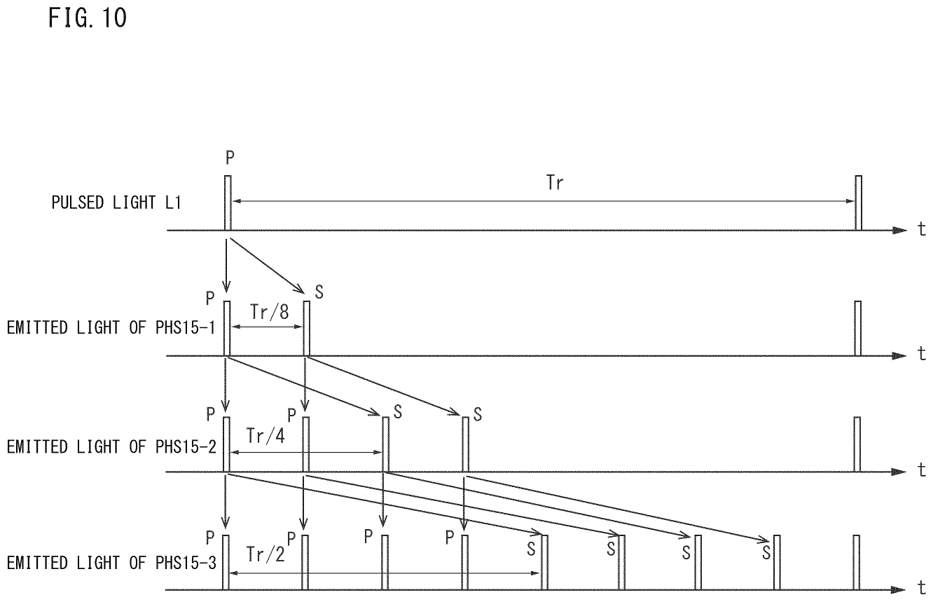

FIGS. 9A, 9B, and 9C are diagrams showing the relationship between polarization of pulsed light and the angle with the optical axis of a half-wave plate. FIG. 9 exemplifies a case where the angle θ is set within the first angular range (for example), 22.5° for all the half-wave plates 30-1 through 30-3. FIG. 9A shows the relationship between the polarization of the pulsed light incident on the optical unit 20-1, the polarization of the pulsed light emitted from the optical unit 20-1, and the angle θ of the half-wave plate 30-1. FIG. 9B shows the relationship between the polarization of the pulsed light incident on the optical unit 20-2, the polarization of the pulsed light emitted from the optical unit 20-2, and the angle θ of the half-wave plate 30-2. FIG. 9C shows the relationship between the polarization of the pulsed light incident on the optical unit 20-3, the polarization of the pulsed light emitted from the optical unit 20-2, and the angle θ of the half-wave plate 30-3. FIG. 10 is a schematic diagram of time intervals and polarization of incident light and emitted light in each pulse converter.

When the repetition frequency fr of pulsed light L1 incident on the optical device 4 is changed to fr×8, that is, changed by a factor of 23 (n=3), the angles θ of the half-wave plate 30-1, the half-wave plate 30-2, and the half-wave plate 30-3 are all set within the first angular range as shown in FIG. 7.

As shown in FIG. 9A, the pulsed light immediately after passing through the half-wave plate 30-1 becomes linearly polarized at 45°. Therefore, as shown in FIGS. 8A, of the pulsed light output from the half-wave plate 30-1, that is, of the 45° linearly polarized light, the P-polarized light P21 is transmitted through the first polarizing beam splitter 21-1, while the S-polarized light S21 is reflected by the first polarizing beam splitter 21-1. The P-polarized light P21, having been transmitted through the first polarizing beam splitter 21-1, propagates along the first optical path 24-1 and is incident on the second polarizing beam splitter 23-1.

On the other hand, the S-polarized light S21, having been reflected by the first polarizing beam splitter 21-1, propagates along the second optical path 25-1 and is incident on the second polarizing beam splitter 23-1. Therefore, a time difference corresponding to the first optical path difference, that is, a time difference of Tr/8, is imparted between the P-polarized light P21 and the S-polarized light S21 (see FIG. 10). The second polarizing beam splitter 23-1, by combining the incident P-polarized light P21 and the S-polarized light S21, generates pulsed light 200. The pulsed light 200 is incident on the optical unit 20-2. The pulsed light 200 is linearly polarized, consisting of the mutually orthogonal P-polarized light P21 and S-polarized light S21, as shown in FIG. 9A.

As shown in FIG. 9B, since the angle θ of the half-wave plate 30-2 is within the first angular range, the pulsed light 200, after passing through the half-wave plate 30-2 as shown in FIG. 8A, is polarized into linearly polarized light at +45° and linearly polarized light at −45°, respectively. Of the temporally leading +45° polarized light, the P-polarized light P22 is transmitted through the first polarizing beam splitter 21-2 and propagates along the first optical path 24-2, while the S-polarized light S22 is reflected by the first polarizing beam splitter 21-2 and propagates along the second optical path 25-2.

Of the −45° linearly polarized light, the P-polarized light P22 is transmitted through the first polarizing beam splitter 21-2 and propagates along the first optical path 24-2. Of the −45° linearly polarized light, the S-polarized light S22 is reflected by the first polarizing beam splitter 21-2 and propagates along the second optical path 25-2. Consequently, a time difference of (Tr/4) is imparted between the split P-polarized lights P22 and the split S-polarized lights S22, respectively (see FIG. 10). The second polarizing beam splitter 23-2, by combining the two incident P-polarized lights P22 and the two S-polarized lights S22, generates pulsed light 210. The pulsed light 210 generated by the second polarizing beam splitter 23-2 is incident on the optical unit 20-3.

The pulsed light 210 emitted from the optical unit 20-2, that is, the four pulses, is incident on the half-wave plate 30-3 of the optical unit 20-3. Here, since the angle θ of the half-wave plate 30-3 is within the first angular range, as shown in FIG. 9C, the pulsed light 210, after passing through the half-wave plate 30-3, is polarized into 45° polarized light consisting of the mutually orthogonal P-polarized light and S-polarized light. In the pulsed light 210 after passing through the half-wave plate 30-3, the two temporally leading pulses are linearly polarized at +45°, and the two temporally trailing pulses are linearly polarized at −45°.

In each of the two temporally leading+45° polarized pulses, the P-polarized light P23 is transmitted through the first polarizing beam splitter 21-3, as shown in FIGS. 8A, and propagates along the first optical path 24-3, while the S-polarized light S23 is reflected by the first polarizing beam splitter 21-3 and propagates along the second optical path 25-3. In each of the two temporally trailing −45° polarized pulses, the P-polarized light P23 is transmitted through the first polarizing beam splitter 21-3 and propagates along the first optical path 24-3, while the S-polarized light S23 is reflected by the first polarizing beam splitter 21-3 and propagates along the second optical path 25-3. Consequently, a time difference of (Tr/2) is imparted between the split P-polarized lights P23 and the split S-polarized lights S23, respectively (see FIG. 10).

The second polarizing beam splitter 23-3, by combining the four incident P-polarized lights P23 and the four incident S-polarized lights S23, generates pulsed light 220 with a repetition frequency of (fr×8). That is to say, the pulsed light P220 with a pulse interval of (Tr/8) is emitted from the optical device 4 as pulsed light L2.

The controller 11 may control the half-wave plate 30-1, the half-wave plate 30-2, and the half-wave plate 30-3, which are examples of the switcher. Each of the half-wave plate 30-1, the half-wave plate 30-2, and the half-wave plate 30-3 is capable of performing a switching process to switch the polarization direction of incident pulsed light to either the first direction or the second direction. The controller 11 may control this switching process.

As a specific example, the controller 11 independently controls the rotation of each of the half-wave plates 30-1 through 30-3. For example, the controller 11 may include multiple electric motors to independently rotate each of the half-wave plate 30-1, the half-wave plate 30-2, and the half-wave plate 30-3. The controller 11 controls the switching of the polarization direction of pulsed light performed by the half-wave plate 30-1 by controlling the rotation of the half-wave plate 30-1 to set the angle θ1 within either the first angular range or the second angular range. The controller 11 controls the switching of the polarization direction of pulsed light performed by the half-wave plate 30-2 by controlling the rotation of the half-wave plate 30-2 to set the angle θ2 within either the first angular range or the second angular range. The controller 11 controls the switching of the polarization direction of pulsed light performed by the half-wave plate 30-3 by controlling the rotation of the half-wave plate 30-3 to set the angle θ3 within either the first angular range or the second angular range.

The controller 11 controls the rotation of each of the half-wave plates 30-1 through 30-3 based on instruction signals from the setter 12. However, the invention is not limited to this configuration, and the controller 11 may control the rotation of each of the half-wave plates 30-1 through 30-3 based on instruction signals from external devices other than the setter 12.

The setter 12, through user operation, sets the value of m (an integer from 0 through n) corresponding to the repetition frequency multiplication factor. For example, the setter 12 includes an operation unit 121 that accepts user operations. Examples of the operation unit 121 include pointing devices such as a touch panel, touch pad, or mouse, buttons, switches, motion-sensitive controllers, keyboards, mice, gesture input devices, and voice input devices (for example, a microphone). When the value of m is set by the operation unit 121, the setter 12 transmits information representing the set value of m (instruction signal) to the controller 11. As a result, the controller 11 controls the rotation of the half-wave plate 30 based on the instruction signal containing information on the value of m transmitted from the setter 12, thereby changing the repetition frequency fr of the pulsed light by a factor of 1 or 2″.

An example of the method for setting the repetition frequency by a factor of 1 or 2ⁿ according to the first embodiment will be described below. First, the user operates the operation unit 121 to set the repetition frequency of the pulsed light L2. For example, the user operates the operation unit 121 to set the value of m. When the value of m is set, the setter 12 transmits an instruction signal containing information on the value of m to the controller 11. The controller 11 causes the half-wave plate 30 to change the repetition frequency fr based on the information on the value of m contained in the instruction signal.

For example, when the value of m in the instruction signal is “0”, the controller 11 controls the rotation of the half-wave plate 30-1, the half-wave plate 30-2, and the half-wave plate 30-3 so that the angles θ1 through θ3 are all set within the second angular range. For example, when the value of m in the instruction signal is “1”, the controller 11 controls the rotation of the half-wave plate 30-1, the half-wave plate 30-2, and the half-wave plate 30-3 so that the angle θ1 and the angle θ2 are set within the second angular range, and the angle θ3 is set within the first angular range.

For example, when the value of m in the instruction signal is “2”, the controller 11 controls the rotation of the half-wave plate 30-1, the half-wave plate 30-2, and the half-wave plate 30-3 so that the angle θ1 is set within the second angular range, and the angle θ2 and the angle θ3 are set within the first angular range. For example, when the value of m in the instruction signal is “3”, the controller 11 controls the rotation of the half-wave plate 30-1, the half-wave plate 30-2, and the half-wave plate 30-3 so that the angles θ1 through θ3 are all set within the first angular range.

However, the method for setting the repetition frequency by a factor of 1 or 2ⁿ is not limited to the method described above and may be set manually by the user, for example. For example, the user may manually adjust the rotation of the half-wave plate 30-1, the half-wave plate 30-2, and the half-wave plate 30-3.

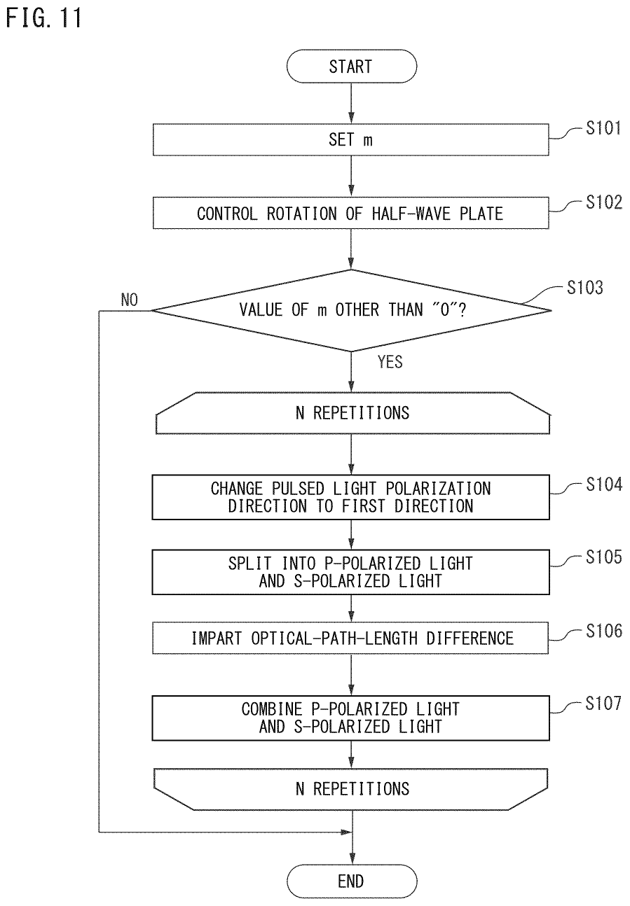

A flow of the method for converting a repetition frequency (by a factor of 1, or fr×2ⁿ) according to the first embodiment will be described below, with reference to FIG. 11. FIG. 11 is a diagram for describing the flow of the conversion method according to the first embodiment.

The value of m is set by the setter 12 (Step S101). When the value of m is set, the angle θ of the half-wave plate 30 is set by the user or the controller 11 according to the value of m (Step S102). If the value of m is other than “0” (Step S103: YES), then following Step S102, when linearly polarized pulsed light L1 with a repetition frequency fr and a repetition period Tr from the light source 2 is input to the optical device 4, the optical device 4 performs a first stage for changing the polarization direction of the pulsed light L1 to the first direction via the half-wave plate 30 (Step S104). Next, the optical device 4 performs a second stage for splitting the pulsed light polarized in the first direction into P-polarized light and S-polarized light using the first polarizing beam splitter 21 (Step S105) and then performs a third stage for imparting an optical-path-length difference between the split P-polarized light and the S-polarized light (Step S106).

The optical device 4 then performs a fourth stage for generating pulsed light with the changed repetition frequency by combining the P-polarized light and the S-polarized light, after an optical-path-length difference has been imparted in the third stage, using the second polarizing beam splitter 23 (Step S107). By repeating n-iterations the series of processes, including the first stage, the second stage, the third stage, and the fourth stage, the optical device 4 converts the pulsed light L1 with the repetition frequency fr into pulsed light L2 with a repetition frequency of fr×2ⁿ. It should be noted that in the first stage, for the second and subsequent iterations of the first-stage process, the optical device 4 changes the polarization direction of the pulsed light generated in the fourth stage, rather than the polarization direction of the pulsed light L1, to the first direction via the half-wave plate 30. If the value of m is “0” (Step S103: NO), then following Step S102, when linearly polarized pulsed light L1 with a repetition frequency fr and a repetition period Tr from the light source 2 is input to the optical device 4, the optical device 4 does not perform the first stage for changing the polarization direction of the pulsed light L1 to the first direction via the half-wave plate 30. Therefore, the pulsed light L1 with the repetition frequency fr is converted into pulsed light L2 with the same repetition frequency (multiplied by a factor of 1) without performing the series of processes including the first stage, the second stage, the third stage, and the fourth stage.

The optical device 4 of the first embodiment includes optical units 20 that convert the repetition frequency fr of pulsed light L emitted from the light source 2, and half-wave plates 30 that can change the repetition frequency converted (by a factor of 1, or fr×2ⁿ) by the optical units 20. With such a configuration, the repetition frequency of pulsed light can be changed as appropriate based on the circumstances, contributing to improved practicality.

For example, nonlinear optical microscopes employing ultrashort pulsed light as excitation light have become essential tools in bioimaging. Notably, two-photon fluorescence microscopes, which utilize two-photon excitation, are widely used as techniques with excellent deep observation capabilities. However, photobleaching caused by laser light emission has become a practical issue. One of the factors contributing to this photobleaching is the emission of pulsed light with extremely high peak intensity.

There is a method for reducing photobleaching by setting a high repetition frequency for ultrashort pulsed light and, in exchange, reducing the peak intensity of the excitation pulses. However, in a two-photon fluorescence microscope, when the excitation pulse is set to a higher repetition frequency by a factor of n, the excitation light intensity (average intensity of excitation light (W)) needed to achieve the same fluorescence level as pulsed light L1 is increased by a factor of Vn. The peak intensity (W) of pulsed light L2 is increased by a factor of 1/√n. In other words, the higher the repetition frequency is set, the greater the required light source output becomes. When observing deep within a biological sample, the excitation light intensity at the objective lens focal plane is reduced due to scattering, thus requiring an increase in the intensity of excitation light incident on the objective lens compared to when observing an interface. Therefore, while it may be necessary to maximize the use of light source output to obtain sufficient fluorescence signals from deep within the sample, the excitation light intensity may be insufficient when the repetition frequency is set high.

In the first embodiment, since the repetition frequency of the pulsed light L1 converted by the optical device 4 is variable, when the excitation light intensity is insufficient for observing deep within a sample, the repetition frequency can be reduced to ensure significant signals are obtained from the deep observation region of the biological sample. This allows the optical device 4 to enable deep observation while maintaining the advantages of reduced photobleaching during observation.

In the first embodiment, the optical path length through the optical elements (the first polarizing beam splitter 21 and the second polarizing beam splitter 23) is the same for all pulses. Therefore, the group delay dispersion (GDD), which is defined by the thickness of the optical elements, is the same regardless of the pulse. The width of all pulses can be optimized by a dispersion compensation optical system associated with the light source 2 or by a dispersion compensation optical system not shown in the drawings.

In the first embodiment, the pulse interval of the pulsed light L2 emitted from the optical device 4 is uniform. In the optical device 4, setting the optical-path-length difference between the P-polarized light and the S-polarized light to Tr/2, Tr/4, Tr/8, . . . , Tr/2″ facilitates the design of a system with a uniform pulse interval.

An adjustment mechanism for beam alignment may be provided in the optical path having a longer optical path length in each pulse converter. The adjustment mechanism includes the angles of two mirrors (M1, M2) installed on the longer optical path. Adjusting the angles of the mirrors aligns the focusing position of the beam at the objective lens with the focusing position of the beam traveling along the shorter optical path. A specific example of beam alignment in the adjustment mechanism will be described below.

Fluorescent beads with a size less than or equal to the diffraction limit (for example, 100 nm or less) are used as the observation object. As an example, a case where the repetition frequency is fr×8 shown in FIGS. 8A and 8B will be described. For the sake of convenience, transmission at the pulse converter 15 is represented as “0”, and reflection is represented as “1”. The pulses transmitted and reflected in each pulse converter 15 are represented as [p3, p2, p1]. pi represents the value in the i-th pulse converter 15 and has a value of either 0 or 1. The focusing position of eight pulses is adjusted through the following steps.

### Step 1

The configuration is such that pulsed light is converted to a high repetition rate by the pulse converter 15-1, the pulse converter 15-2, and the pulse converter 15-3. For this purpose, the angles of the half-wave plate 30-1, the half-wave plate 30-2, and the half-wave plate 30-3 are set to 22.5°. In the pulse converter 15-1, the pulse converter 15-2, and the pulse converter 15-3, a shutter not shown in the drawings is provided in both the first optical path 24 transmitted through the first polarizing beam splitter 21 and the second optical path 25 reflected by the first polarizing beam splitter 21. The shutters arranged in the second optical path 25-2 of the pulse converter 15-2 and the second optical path 25-3 of the pulse converter 15-3 are both closed. With such a setting, two pulsed lights L2 with a time difference of Tr/8 are emitted from the optical device 4. Hereinafter, in the pulse converter 15-1, the pulse transmitted through the first polarizing beam splitter 21-1 is represented as [0, 0, 0], and the pulse reflected by the first polarizing beam splitter 21-1 is represented as [0, 0, 1]. These two pulses are transmitted through the first polarizing beam splitter 21-2 in the pulse converter 15-2 and transmitted through the first polarizing beam splitter 21-3 in the pulse converter 15-3.

It is assumed that the optical system of the microscope is adjusted for the pulse [0, 0, 0]. That is, the pulse [0,0,0] is focused at the ideal focusing position of the objective lens. A fluorescent bead image is acquired using only the pulse [0, 0, 0] by closing the shutter arranged in the second optical path 25-1 of the pulse converter 15-1, and a fluorescent bead image is acquired using only the pulse [0, 0, 1] by closing the shutter arranged in the first optical path 24-1 of the pulse converter 15-1. If there is a misalignment in the fluorescent bead images, the focusing position of the pulse [0, 0, 1] is aligned with that of the pulse [0, 0, 0] using two mirrors (M1-1, M2-1) installed in the pulse converter 15-1.

### Step 2

The focusing positions of the pulses transmitted through and reflected by the first polarizing beam splitter 21-2 in the pulse converter 15-2 are adjusted. Of the four pulses generated in the pulse converter 15-1 and the pulse converter 15-2, two pulses that pass through different optical paths within the pulse converter 15-2 are used. Here, as an example, the pulses [0, 1, 0] and [0,0,0] are used. By closing a predetermined shutter, two pulses, [0, 1, 0] and [0, 0, 0], are extracted, and fluorescent bead images are each acquired independently. If there is a misalignment in the fluorescent bead images, the focusing position of the pulse [0, 1, 0] is aligned with that of the pulse [0,0,0] using two mirrors (M1-2, M2-2) installed in the pulse converter 15-2.

### Step 3

The focusing positions of the pulses transmitted through and reflected by the first polarizing beam splitter in the pulse converter 15-3 are adjusted. Of the eight pulses generated in the pulse converter 15-1, the pulse converter 15-2, and the pulse converter 15-3, two pulses that pass through different optical paths within the pulse converter 15-3 are used. Here, as an example, the pulses [1, 0, 0] and [0,0,0] are used. By closing a predetermined shutter, two pulses, [1, 0, 0] and [0, 0, 0], are extracted, and fluorescent bead images are each acquired independently. If there is a misalignment in the fluorescent bead images, the focusing position of the pulse [1, 0, 0] is aligned with that of the pulse [0, 0, 0] using two mirrors (M1-3, M2-3) installed in the pulse converter 15-3.

By performing the above three steps, STEP 1 through STEP 3, the focusing positions of the eight pulses are aligned on the objective lens focal plane. The alignment accuracy is preferably equal to or less than the full width at half maximum of the spot diameter (point spread function) generated by the pulse [0, 0, 0] on the objective lens focal plane. More preferably, it is desirable that it is equal to or less than the half width at half maximum.

If the focusing position on the focal plane of the objective lens shifts, for example, due to changes over time, the acquired image will be a superposition of fluorescence excited by beams with different focusing positions, thus degrading the spatial resolution. In such a case, beam alignment is performed as described above.

To address the aforementioned changes over time, a mechanism for verifying the presence or absence of beam spot misalignment may be provided. Specifically, fluorescent bead images below the diffraction limit may be acquired using pulses that pass through different optical paths (pulses with varying time delays), and these images can be compared to detect any spot misalignment. The detection may be performed using techniques such as image correlation or centroid position analysis.

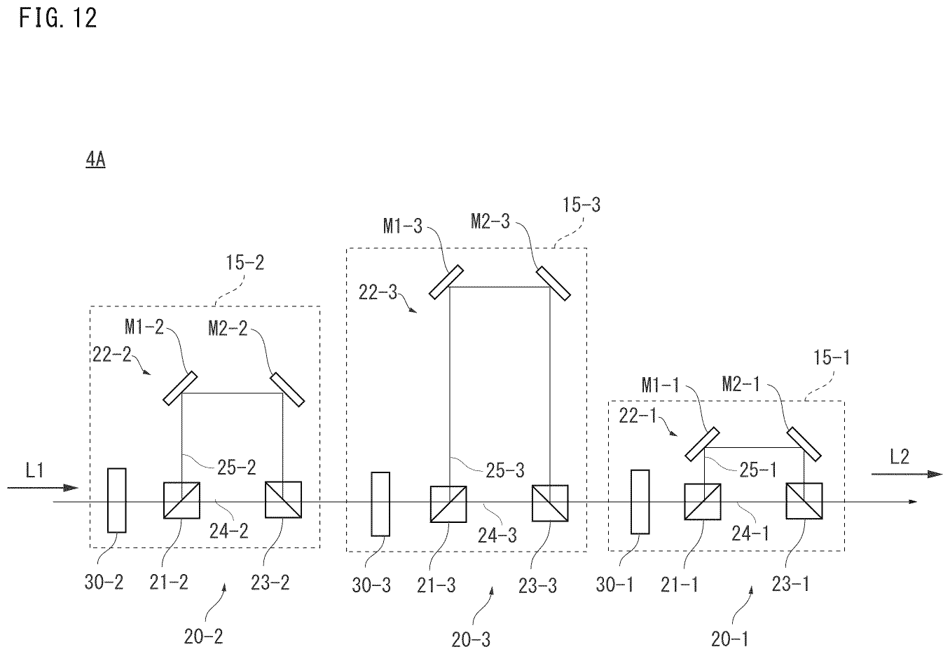

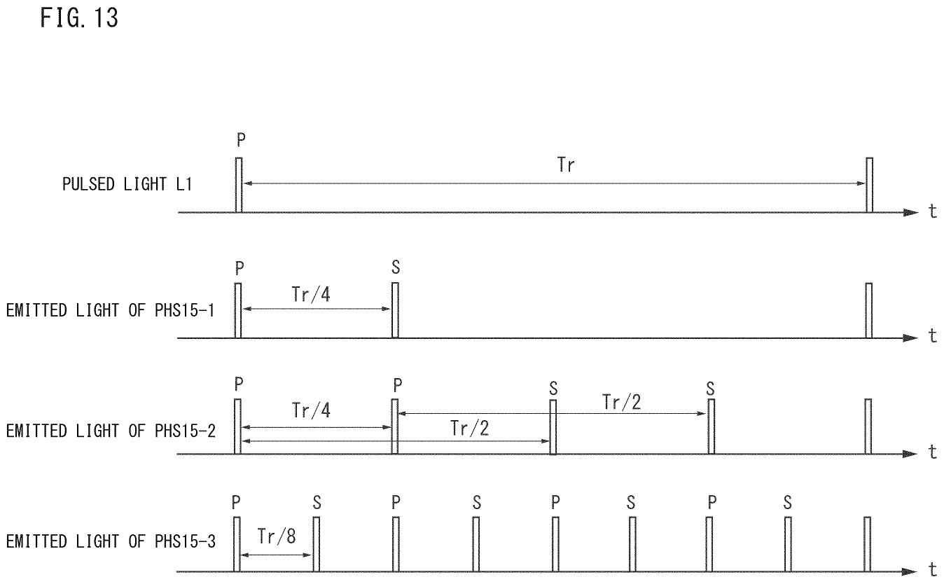

FIG. 12 is a diagram showing a modified example of the optical device 4 according to the first embodiment. An optical device 4A of the modified example shown in FIG. 12 differs from the optical device 4 shown in FIG. 2 in the arrangement order of the pulse converters 15-1 through 15-3, but the other configurations are the same. FIG. 13 is a schematic diagram showing the time intervals and polarizations of the incident and emitted light in each pulse converter of the optical device 4A.

When the direction of linear polarization of excitation pulses is orthogonal for each successive pulse over time, the direction of polarization induced in the observation object varies with each pulse, which is useful for suppressing photobleaching. The polarization dependence of the observation object O can be averaged, allowing for the signal detection to be independent of the orientation of the observation object O. The optical device 4A shown in FIG. 12 arranges the direction of the linearly polarized excitation pulses orthogonally for each successive pulse at high repetition rates.

In the optical device 4A, the pulse converter 15-2, the pulse converter 15-3, and the pulse converter 15-1 are arranged in this order from the direction in which the pulsed light L1 is incident. Thus, as shown in FIG. 13, the optical device 4A can achieve orthogonal polarization for each pulse when converting the repetition frequency to fr×8 (n=3).

In the configuration of the optical device 4A shown in FIG. 12, when n=1, only the angle θ1 of the half-wave plate 30-1 is set within the first angular range, while the angles θ2, θ3 of the half-wave plate 30-2 and the half-wave plate 30-3 are set within the second angular range. When n=2, the angle θ1 of the half-wave plate 30-1 and the angle θ3 of the half-wave plate 30-3 are set in the first angular range, and the angle θ2 of the half-wave plate 30-2 is set in the second angular range. In these cases, the pulse intervals are not equal. If it is desired to further increase n, an additional pulse converter may be added to the subsequent stage of the pulse converter 15-1 shown in FIG. 12. When n=4, a pulse converter having a time difference of Tr/24 may be added to the subsequent stage of the pulse converter 15-1. Thus, the pulse converter that imparts the shortest time difference between P-polarized light and S-polarized light may be arranged at the end of the pulse converters arranged in series.

Alternatively, the optical device 4 may not include the function of changing the repetition frequency fr of the pulsed light L1, and the repetition frequency may be fixed at a specific frequency. In such a case, for example, when used exclusively for multiplication of fr×2, the optical device 4 includes only the pulse converter 15-3, which has the optical unit 20-3 and the half-wave plate 30-3, with the angle θ of the half-wave plate 30-3 being set in a fixed manner within the first angular range (for example, 22.5°).

When used exclusively for multiplication of fr×4, the optical device 4 includes only the pulse converter 15-2 having the optical unit 20-2 and the half-wave plate 30-2, and the pulse converter 15-3 having the optical unit 20-3 and the half-wave plate 30-3, and the angles θ of the half-wave plate 30-2 and the half-wave plate 30-3 are both fixed within the first angular range (for example, 22.5°).

When used exclusively for multiplication of fr×8, the optical device 4 includes the pulse converter 15-1 having the optical unit 20-1 and the half-wave plate 30-1, the pulse converter 15-2 having the optical unit 20-2 and the half-wave plate 30-2, and the pulse converter 15-3 having the optical unit 20-3 and the half-wave plate 30-3, and the angles θ of the half-wave plate 30-1, the half-wave plate 30-2, and the half-wave plate 30-3 are all fixed within the first angular range (for example), 22.5°.

### Second Embodiment

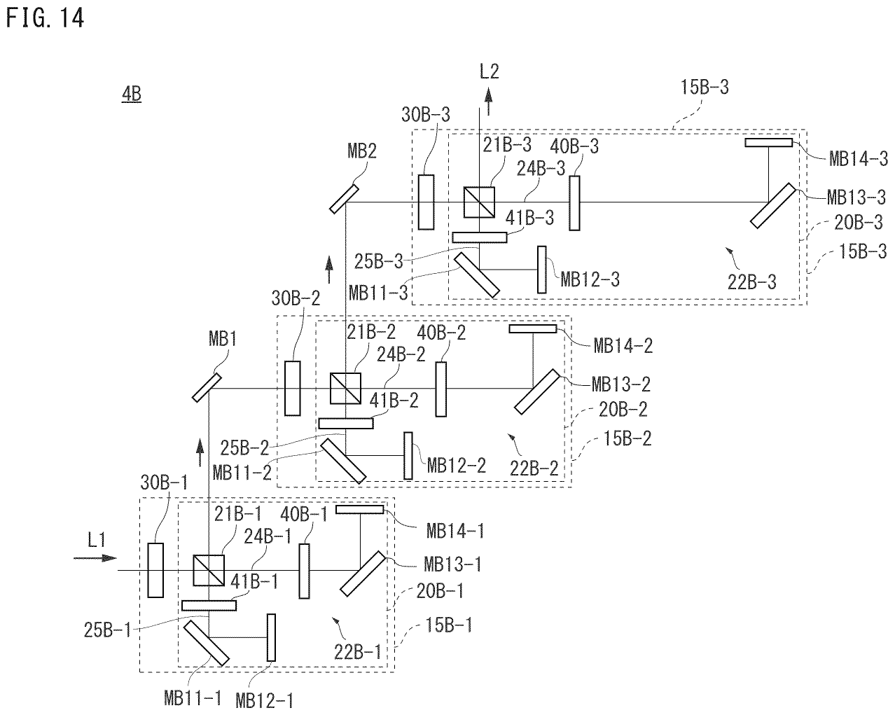

A microscope according to a second embodiment is identical to the microscope 1 according to the first embodiment shown in FIG. 1, except that the optical device 4 is replaced with an optical device 4B shown in FIG. 14.

The optical device 4B is capable of converting the repetition frequency fr of pulsed light L1 emitted from the light source 2 to a repetition frequency different from the repetition frequency fr. For example, the optical device 4B converts the repetition frequency fr by a maximum factor of 2ⁿ (where n is an integer greater than or equal to one). The optical device 4B splits the pulsed light into P-polarized light and S-polarized light orthogonal to the P-polarized light, imparts a predetermined optical-path-length difference between the P-polarized light and the S-polarized light, and then combines the P-polarized light and the S-polarized light after imparting the optical-path-length difference. This series of processes is performed n iterations (where n is an integer from 1 through n), thereby converting the repetition frequency by a factor of 2ⁿ. The optical device 4B may be configured to be removably inserted in the microscope 1.

FIG. 14 is a diagram showing a configuration example of the optical device 4B according to the second embodiment. The optical device 4B includes, for example, n units of pulse converters 15B and multiple mirrors MB. The optical device 4B exemplified in FIG. 14 includes three pulse converters 15B-1 through 15B-3, and two mirrors MB1, MB2.

The pulse converter 15B includes an optical unit 20B and a half-wave plate 30B. The optical unit 20B is an example of the converter. The half-wave plate 30B is an example of the switcher. The optical unit 20B includes a polarizing beam splitter 21B and an optical-path-length-difference imparter 22B.

The polarizing beam splitter 21B splits pulsed light polarized in a first direction into P-polarized light and S-polarized light. In other words, when the incident pulsed light is polarized in the first direction, the polarizing beam splitter 21B transmits the P-polarized light component of the pulsed light and reflects the S-polarized light component of the pulsed light in a predetermined direction. When the incident pulsed light is polarized in a second direction other than the first direction, the polarizing beam splitter 21B does not split the pulsed light. Therefore, the pulsed light polarized in the second direction (for example, P-polarized light) is transmitted directly through the polarizing beam splitter 21B. The polarizing beam splitter 21B forms pulsed light the repetition frequency of which is changed by combining the P-polarized light and the S-polarized light after the optical-path-length difference is imparted by the optical-path-length-difference imparter 22B. In other words, the polarizing beam splitter 21B has the function of the first polarizing beam splitter 21 and the function of the second polarizing beam splitter 23 described in the first embodiment.

The optical-path-length-difference imparter 22B imparts an optical-path-length difference between the P-polarized light and the S-polarized light split by the polarizing beam splitter 21B. For example, the optical-path-length-difference imparter 22B includes a first optical path 24B and a second optical path 25B.

In the first optical path 24B, a quarter-wave plate 40B, a mirror MB11, and a mirror MB12 are provided. The quarter-wave plate 40B converts the P-polarized light, split by the polarizing beam splitter 21B, into circularly polarized light. The circularly polarized light is reflected by the mirror MB11 and the mirror MB12 and is incident on the quarter-wave plate 40B again. The circularly polarized light incident on the quarter-wave plate 40B is converted into S-polarized light by the quarter-wave plate 40B. The S-polarized light converted by the quarter-wave plate 40B is reflected by the polarizing beam splitter 21B and is emitted from the optical unit 20B.

In the second optical path 25B, a quarter-wave plate 41B, a mirror MB13, and a mirror MB14 are provided. The quarter-wave plate 41B converts the S-polarized light, split by the polarizing beam splitter 21B, into circularly polarized light. The circularly polarized light is reflected by the mirror MB13 and the mirror MB14 and is incident on the quarter-wave plate 41B again. The circularly polarized light incident on the quarter-wave plate 41B is converted into P-polarized light by the quarter-wave plate 41B. The P-polarized light converted by the quarter-wave plate 41B is transmitted through the polarizing beam splitter 21B and is emitted from the optical unit 20B. Here, the optical path length of the second optical path 25B is shorter than the optical path length of the first optical path 24B. Therefore, the optical-path-length-difference imparter 22 can impart an optical-path-length difference between the P-polarized light and the S-polarized light.

An optical-path-length-difference imparter 22B-1 imparts a first optical-path-length difference between the P-polarized light and the S-polarized light split by a polarizing beam splitter 21B-1. This first optical-path-length difference imparts a time difference of (Tr/8) between the P-polarized light and the S-polarized light.

An optical-path-length-difference imparter 22B-2 imparts a second optical-path-length difference between the P-polarized light and the S-polarized light split by a polarizing beam splitter 21B-2. The second optical-path-length difference is greater than the first optical-path-length difference. This second optical-path-length difference imparts a time difference of (Tr/4) between the P-polarized light and the S-polarized light.

An optical-path-length-difference imparter 22B-3 imparts a third optical-path-length difference between the P-polarized light and the S-polarized light split by the polarizing beam splitter 21B. The third optical-path-length difference is greater than the second optical-path-length difference. This third optical-path-length difference imparts a time difference of (Tr/2) between the P-polarized light and the S-polarized light.

The half-wave plate 30B changes the polarization direction of the pulsed light incident on the polarizing beam splitter 21B in each optical unit 20B to either the first direction or the second direction, which is different from the first direction. The half-wave plate 30B is rotatable. Rotating the half-wave plate 30B changes the angle θ_{B} between the polarization direction of the pulsed light incident on the half-wave plate 30B and the optical axis (slow axis or fast axis) of the half-wave plate 30B. For example, rotating the half-wave plate 30B allows switching between a first state where the angle θ_{B} is within a first angular range, and a second state where the angle θ_{B} is within a second angular range. When the angle θ_{B} is within the first angular range, the pulsed light in the first direction is emitted from the half-wave plate 30B. When the angle θ_{B} is within the second angular range, different from the first angular range, the pulsed light in the second direction, different from the first direction, is emitted from the half-wave plate 30B.

The half-wave plate 30B-1 is provided in the preceding stage of the polarizing beam splitter 21B-1. The half-wave plate 30B-1 changes the pulsed light incident on the polarizing beam splitter 21B-1 to either the first direction or the second direction, which is different from the first direction. The half-wave plate 30B-2 is provided in the preceding stage of the polarizing beam splitter 21B-2. The half-wave plate 30B-2 changes the pulsed light emitted from the polarizing beam splitter 21B-1 and incident on the polarizing beam splitter 21B-2 to either the first direction or the second direction, which is different from the first direction. The half-wave plate 30B-3 is provided in the preceding stage of the polarizing beam splitter 21B-3. The half-wave plate 30B-3 changes the pulsed light emitted from the polarizing beam splitter 21B-2 and incident on the polarizing beam splitter 21B-3 to either the first direction or the second direction, which is different from the first direction.

The angle setting of the half-wave plate 30B allows switching of whether or not to cause the optical unit 20B to change the repetition frequency of the pulsed light L1. For example, the repetition frequency fr of the pulsed light L1 can be changed to a value that is a power of 2 times the repetition frequency fr. In other words, the angle setting of the half-wave plate 30 allows switching of whether or not to change the repetition frequency fr within a range from 1 time to 2ⁿ times the repetition frequency fr. In the configuration exemplified in FIG. 14, n=3, and therefore the angle setting of the half-wave plate 30B can change the repetition frequency fr of the pulsed light L1 emitted from the light source 2 to one of four repetition frequencies, namely, fr×1, fr×2, fr×4, and fr×8.

The mirror MB1 reflects the pulsed light emitted from the pulse converter 15B-1 to the pulse converter 15B-2. The mirror MB2 reflects the pulsed light emitted from the pulse converter 15B-2 to the pulse converter 15B-3.

The controller 11 controls the rotation of the half-wave plates 30B-1 through 30B-3. The controller 11 may control the rotation of each of the quarter-wave plates 40B-1 through 40B-2 and the rotation of each of the quarter-wave plates 41B-1 through 41B-3.

As with the first embodiment, the optical device 4B according to the second embodiment can vary the repetition frequency fr of the pulsed light L1 emitted from the light source 2 to one of four repetition frequencies, namely, fr×1, fr×2, fr×4, and fr×8, by controlling the rotation of the half-wave plates 30B-1 through 30B-3. In other words, in the optical device 4B, as with the first embodiment, switching the angle θ_{B} of each of the half-wave plates 30B-1 through 30B-3 between the first angular range and the second angular range allows the repetition frequency fr of the pulsed light L1 emitted from the light source 2 to be varied to one of the four repetition frequencies, namely, fr×1, fr×2, fr×4, and fr×8. The method for varying the repetition frequency using the half-wave plate 30B is the same as that in the first embodiment, and therefore, the description thereof is omitted.

The flow of the method for converting a repetition frequency (by a factor or 1, or fr×2ⁿ) according to the second embodiment, as described below, is the same as that of the first embodiment shown in FIG. 11, and therefore, the description thereof is omitted.

The optical device 4B of the second embodiment includes optical units 20B that convert the repetition frequency fr of pulsed light L emitted from the light source 2, and half-wave plates 30B that can change the repetition frequency converted (by a factor of 1, or fr×2ⁿ) by the optical units 20B. With such a configuration, in addition to achieving the same effects as the first embodiment, the number of polarizing beam splitters per optical unit can be reduced by one compared to the first embodiment, which contributes to improved robustness.

### Third Embodiment

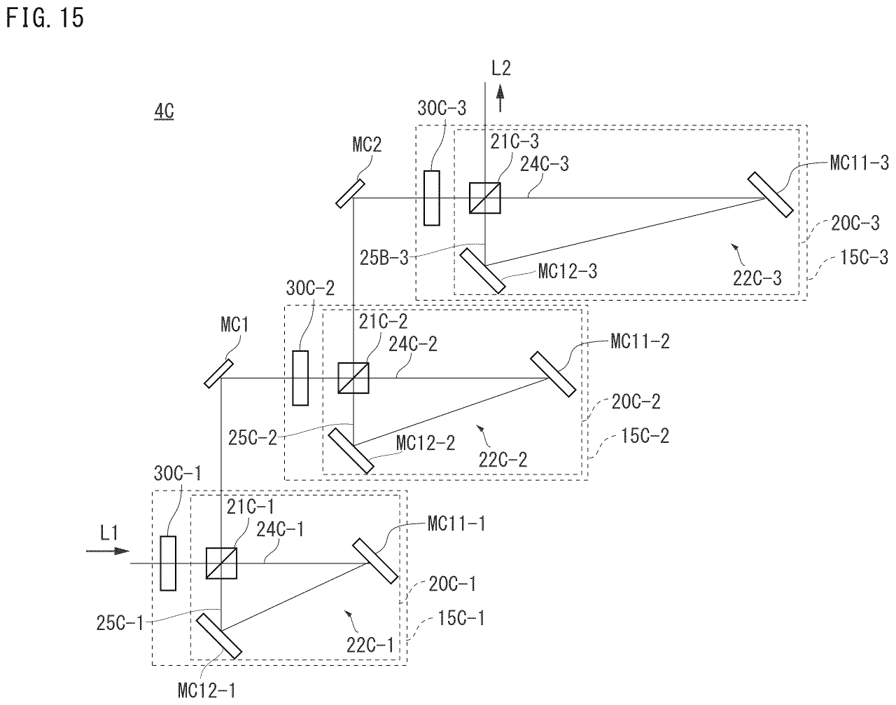

A microscope according to a third embodiment is identical to the microscope 1 according to the first embodiment shown in FIG. 1, except that the optical device 4 is replaced with an optical device 4C shown in FIG. 15.

The optical device 4C is capable of converting the repetition frequency fr of pulsed light L1 emitted from the light source 2 to a repetition frequency different from the repetition frequency fr. For example, the optical device 4C converts the repetition frequency fr by a maximum factor of 2ⁿ (where n is an integer greater than or equal to one). The optical device 4C splits pulsed light into P-polarized light and S-polarized light orthogonal to the P-polarized light, imparts a predetermined optical-path-length difference between the P-polarized light and the S-polarized light, and then combines the P-polarized light and the S-polarized light after imparting the optical-path-length difference. This series of processes is performed n iterations (where n is an integer from 1 through n), thereby converting the repetition frequency by a factor of 2ⁿ. The optical device 4C may be configured to be removably inserted in the microscope 1.

FIG. 15 is a diagram showing a configuration example of the optical device 4C according to the first embodiment. The optical device 4C includes, for example, n units of pulse converters 15C and multiple mirrors MC. The optical device 4C exemplified in FIG. 15 includes three pulse converters 15C-1 through 15C-3, and two mirrors MC1, MC2.

The pulse converter 15C includes an optical unit 20C and a half-wave plate 30C. The optical unit 20C is an example of the converter. The half-wave plate 30C is an example of the switcher. The optical unit 20C includes a polarizing beam splitter 21C and an optical-path-length-difference imparter 22C.

The polarizing beam splitter 21C splits the pulsed light polarized in a first direction into P-polarized light and S-polarized light. In other words, when the incident pulsed light is polarized in the first direction, the polarizing beam splitter 21C transmits the P-polarized light component of the pulsed light and reflects the S-polarized light component of the pulsed light in a predetermined direction. When the incident pulsed light is polarized in a second direction other than the first direction, the polarizing beam splitter 21C does not split the pulsed light. Therefore, the pulsed light polarized in the second direction is transmitted directly through the polarizing beam splitter 21C. The polarizing beam splitter 21C forms pulsed light the repetition frequency of which is changed by combining the P-polarized light and the S-polarized light after an optical-path-length difference is imparted by the optical-path-length-difference imparter 22C. The polarizing beam splitter 21C has the function of the first polarizing beam splitter 21 and the function of the second polarizing beam splitter 23 described in the first embodiment.

The optical-path-length-difference imparter 22C imparts an optical-path-length difference between the P-polarized light and the S-polarized light split by the polarizing beam splitter 21C. For example, the optical-path-length-difference imparter 22C includes an optical path 24C.

A mirror MC11 and a mirror MC12 are provided in the optical path 24C. The P-polarized light transmitted through the polarizing beam splitter 21C propagates along the optical path 24C, is reflected by the mirrors MC11, MC12, is incident on the polarizing beam splitter 21C again, and is transmitted therethrough. Through this propagation, an optical path difference is imparted between the S-polarized light and P-polarized light by the optical path 24C, and this optical path difference imparts a predetermined time difference between the S-polarized light and P-polarized light.

The optical-path-length-difference imparter 22C-1 imparts a first optical-path-length difference between the P-polarized light and the S-polarized light split by the polarizing beam splitter 21C-1. The first optical-path-length difference imparts a time difference of (Tr/8) between the P-polarized light and the S-polarized light.

The optical-path-length-difference imparter 22C-2 imparts a second optical-path-length difference between the P-polarized light and the S-polarized light split by the polarizing beam splitter 21C-2. The second optical-path-length difference is greater than the first optical-path-length difference. This second optical-path-length difference imparts a time difference of (Tr/4) between the P-polarized light and the S-polarized light.

The optical-path-length-difference imparter 22C-3 imparts a third optical-path-length difference between the P-polarized light and the S-polarized light split by the polarizing beam splitter 21C-3. The third optical-path-length difference is greater than the second optical-path-length difference. This third optical-path-length difference imparts a time difference of (Tr/2) between the P-polarized light and the S-polarized light.

The half-wave plate 30C changes the polarization direction of the pulsed light incident on the polarizing beam splitter 21C in each optical unit 20C to either the first direction or the second direction, which is different from the first direction. The half-wave plate 30C is rotatable. By rotating the half-wave plate 30C, the angle θ_{C} of the half-wave plate 30C is changed.

For example, rotating the half-wave plate 30C allows switching between a first state where the angle θ_{C} is within a first angular range, and a second state where the angle θ_{C} is within a second angular range. When the angle θ_{C} is within the first angular range, the pulsed light in the first direction is emitted from the half-wave plate 30C. When the angle θ_{C} is within the second angular range, different from the first angular range, the pulsed light in the second direction, different from the first direction, is emitted from the half-wave plate 30.

The half-wave plate 30C-1 is provided in the preceding stage of the polarizing beam splitter 21C-1. The half-wave plate 30C-1 changes the polarization direction of the pulsed light incident on the polarizing beam splitter 21C-1 to either the first direction or the second direction, which is different from the first direction.

The half-wave plate 30C-2 is provided in the preceding stage of the polarizing beam splitter 21C-2. The half-wave plate 30C-2 changes the polarization direction of the pulsed light emitted from the polarizing beam splitter 21C-1 and incident on the polarizing beam splitter 21C-2 to either the first direction or the second direction, which is different from the first direction.

The half-wave plate 30C-3 is provided in the preceding stage of the polarizing beam splitter 21C-3. The half-wave plate 30C-3 changes the polarization direction of the pulsed light emitted from the polarizing beam splitter 21C-2 and incident on the polarizing beam splitter 21C-3 to either the first direction or the second direction, which is different from the first direction.

The angle setting of the half-wave plate 30C allows switching of whether or not to cause the optical unit 20C to change the repetition frequency of the pulsed light L1. For example, the repetition frequency fr of the pulsed light L1 can be changed to a value that is a power of 2 times the repetition frequency fr. In other words, the angle setting of the half-wave plate 30C allows the repetition frequency fr to be changed within a range from 1 time to 2ⁿ times the repetition frequency fr. In the configuration exemplified in FIG. 15, n=3, and therefore the angle setting of the half-wave plate 30C can change the repetition frequency fr of the pulsed light L1 emitted from the light source 2 to one of four repetition frequencies, namely, fr×1, fr×2, fr×4, and fr×8.

The mirror MC1 reflects the pulsed light emitted from the pulse converter 15C-1 toward the pulse converter 15C-2. The mirror MC2 reflects the pulsed light emitted from the pulse converter 15C-2 toward the pulse converter 15C-3.

As with the first embodiment, the optical device 4C according to the third embodiment can vary the repetition frequency fr of the pulsed light L1 emitted from the light source 2 to one of the four repetition frequencies, namely, fr×1, fr×2, fr×4, and fr×8, by controlling the rotation of the half-wave plates 30C-1 through 30C-3. In other words, in the optical device 4C, as with the first embodiment, switching the angle θ_{C} of each of the half-wave plates 30C-1 through 30C-3 between the first angular range and the second angular range allows the repetition frequency fr of the pulsed light L1 emitted from the light source 2 to be varied to one of the four repetition frequencies, namely, fr×1, fr×2, fr×4, and fr×8.

The method for varying the repetition frequency using the half-wave plate 30C is the same as that in the first embodiment, and therefore, the description thereof is omitted. The flow of the method for converting the repetition frequency (by a factor or 1, or fr×2ⁿ) according to the third embodiment is the same as that of the first embodiment shown in FIG. 11, and therefore, the description thereof is omitted.

The optical device 4C of the third embodiment includes optical units 20C that convert the repetition frequency fr of pulsed light L emitted from the light source 2, and half-wave plates 30C that can change the repetition frequency converted (by a factor of 1, or fr×2ⁿ) by the optical units 20C. With such a configuration, in addition to achieving the same effects as the first embodiment, the number of polarizing beam splitters per optical unit can be reduced by one compared to the first embodiment, and the quarter-wave plates 40B can be reduced compared to the second embodiment. This therefore contributes to improved robustness.

### Fourth Embodiment

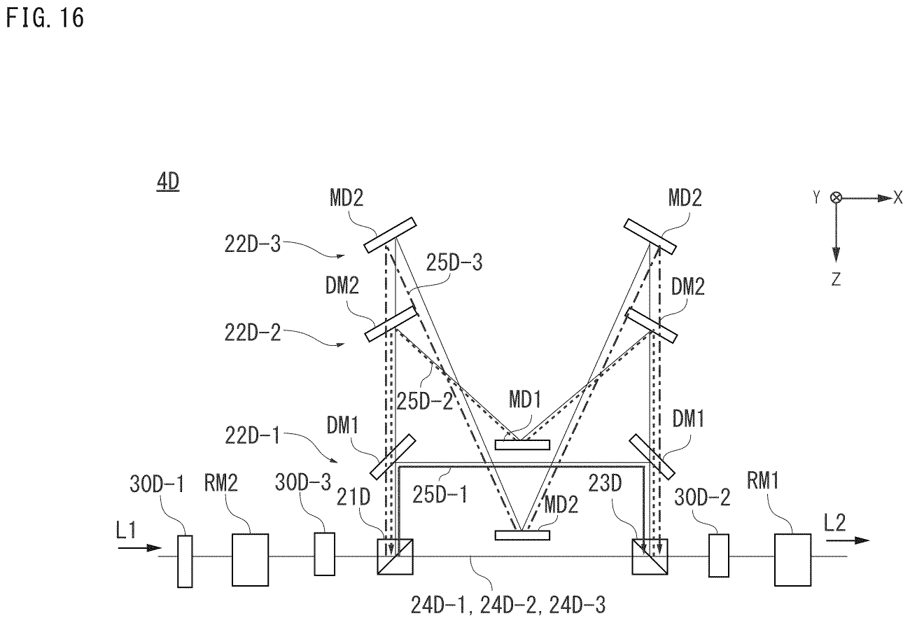

A microscope according to a fourth embodiment is identical to the microscope 1 according to the first embodiment shown in FIG. 1, except that the optical device 4 is replaced with an optical device 4D shown in FIG. 16.

The optical device 4D is capable of converting the repetition frequency fr of the pulsed light L1 emitted from the light source 2 to a repetition frequency different from the repetition frequency fr. For example, the optical device 4D converts the repetition frequency fr by a maximum factor of 2ⁿ (where n is an integer greater than or equal to one). The optical device 4D splits pulsed light into P-polarized light and S-polarized light orthogonal to the P-polarized light, imparts a predetermined optical-path-length difference between the P-polarized light and the S-polarized light, and then combines the P-polarized light and the S-polarized light after imparting the optical-path-length difference. This series of processes is performed n iterations (where n is an integer from 1 through n), thereby converting the repetition frequency by a factor of 2ⁿ. The optical device 4D may be configured to be removably inserted in the microscope 1.

The principle of high pulse repetition in the optical device 4D is identical to that in the first embodiment. However, the optical device 4D according to the fourth embodiment differs in that a single common first polarizing beam splitter 21D is employed for n units of the first polarizing beam splitters 21-1 through 21-n of the first embodiment, and a single common second polarizing beam splitter 23D is employed for n units of the second polarizing beam splitters 23-1 through 23-n of the first embodiment.

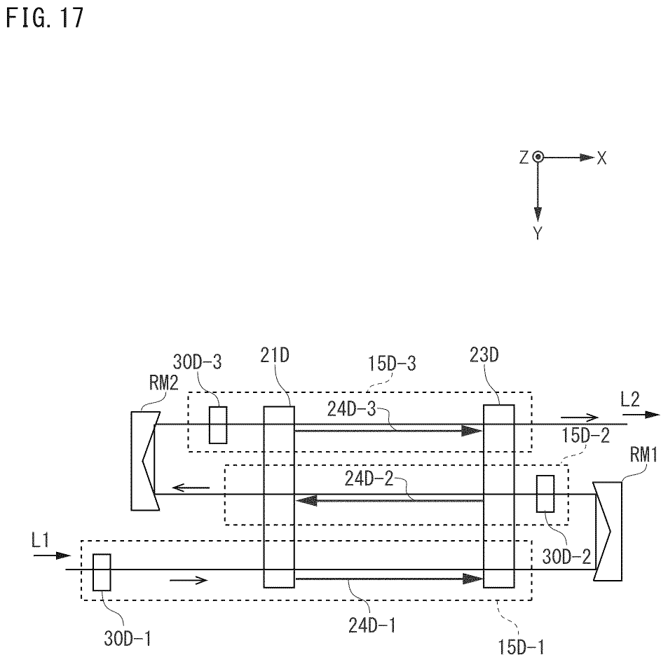

FIG. 16 and FIG. 17 are diagrams showing a configuration example of the optical device 4D according to the fourth embodiment. FIG. 16 is a schematic diagram of the optical device 4D as viewed from above (Y direction). FIG. 17 is a schematic diagram of the optical device 4D as viewed from the front (Z direction). The optical device 4D shown in FIG. 16 and FIG. 17 includes three pulse converters 15D-1 through 15D-3 and two roof mirrors RM1, RM2.

The optical paths of the pulse converters 15D-1 through 15D-3 are at different heights. The pulse converter 15D-1 is located on the lowest optical path. The pulsed light emitted from the pulse converter 15D-1 is reflected by the roof mirror RM1, thus increasing the height of the optical path thereof. Thereafter, the pulsed light is incident on the pulse converter 15D-2. The pulsed light emitted from the pulse converter 15D-2 is reflected by the roof mirror RM2, thus increasing the height of the optical path thereof. Thereafter, the pulsed light is incident on the pulse converter 15D-3.

The pulse converter 15D-1 includes an optical unit 20D-1 and a half-wave plate 30D-1. The optical unit 20D-1 includes a first polarizing beam splitter 21D, an optical-path-length-difference imparter 22D-1, and a second polarizing beam splitter 23D. The optical unit 20D-1 is an example of the converter. The half-wave plate 30D-1 is an example of the switcher.

The first polarizing beam splitter 21D splits the pulsed light L1 polarized in the first direction into P-polarized light and S-polarized light. When the incident pulsed light L1 is polarized in the first direction, the first polarizing beam splitter 21D transmits the P-polarized light component of the pulsed light L1 and reflects the S-polarized light component of the pulsed light L1 in a predetermined direction. When the incident pulsed light L1 is polarized in a second direction other than the first direction, the first polarizing beam splitter 21D does not split the pulsed light L1. Therefore, the pulsed light L1 polarized in the second direction (P-polarized light) is transmitted directly through the polarizing beam splitter 21D-1 without being split.

The optical-path-length-difference imparter 22D-1 imparts a first optical-path-length difference between the P-polarized light and the S-polarized light split by the first polarizing beam splitter 21D. For example, the optical-path-length-difference imparter 22D-1 includes a first optical path 24D-1 and a second optical path 25D-1.

The first optical path 24D-1 is a path through which the P-polarized light transmitted through the first polarizing beam splitter 21D propagates until it reaches the second polarizing beam splitter 23D. In other words, the P-polarized light, having been transmitted through the first polarizing beam splitter 21D, propagates along the first optical path 24D-1 and is incident on the second polarizing beam splitter 23D.

The second optical path 25D-1 is a path through which the S-polarized light reflected by the first polarizing beam splitter 21D propagates until it reaches the second polarizing beam splitter 23D. Two mirrors DM1 are provided in the second optical path 25D. The mirrors DM1 are, for example, of a semicircular shape. The S-polarized light split by the first polarizing beam splitter 21D is reflected by the two mirrors DM1 and is incident on the second polarizing beam splitter 23D. Here, the optical path length of the second optical path 25D-1 is longer than the optical path length of the first optical path 24D-1. Therefore, the optical-path-length-difference imparter 22D-1 can impart the first optical-path-length difference between the P-polarized light and the S-polarized light.

The second polarizing beam splitter 23D forms pulsed light the repetition frequency of which is changed by combining the P-polarized light and the S-polarized light after the first optical-path-length difference is imparted by the optical-path-length-difference imparter 22-1. When the first optical-path-length difference is imparted between the P-polarized light and the S-polarized light, a time difference of (Tr/8) is imparted between the P-polarized light and the S-polarized light during their propagation to the second polarizing beam splitter 23D. Therefore, in the case where the P-polarized light and the S-polarized light are coaxially combined by the second polarizing beam splitter 23D, the repetition frequency of the combined pulsed light is higher than the repetition frequency of the pulsed light L1 incident on the first polarizing beam splitter 21D.

The roof mirror RM1 has, for example, two reflective surfaces, and bends the pulsed light emitted from the second polarizing beam splitter 23D by 180 degrees by reflecting it twice. The pulsed light bent by the roof mirror RM1 is incident on the pulse converter 15D-2. Thus, the pulsed light incident on the roof mirror RM1 is reflected twice and then is incident on the pulse converter 15D-2 from the roof mirror RM1.

The pulse converter 15D-2 includes an optical unit 20D-2 and a half-wave plate 30D-2. The optical unit 20D-2 includes a first polarizing beam splitter 21D, an optical-path-length-difference imparter 22D-2, and a second polarizing beam splitter 23D. The optical unit 20D-2 is an example of the converter. The half-wave plate 30D-2 is an example of the switcher.

The pulsed light from the roof mirror RM1 is incident on the second polarizing beam splitter 23D via the half-wave plate 30D-2. When the pulsed light incident from the half-wave plate 30D-2 is polarized in the first direction, the second polarizing beam splitter 23D splits it into P-polarized light and S-polarized light. In other words, when the pulsed light incident from the half-wave plate 30D-2 is polarized in the first direction, the polarizing beam splitter 23D transmits the P-polarized light of the pulsed light and reflects the S-polarized light component in a predetermined direction. When the pulsed light incident from the half-wave plate 30D-2 is polarized in a second direction other than the first direction, the second polarizing beam splitter 23D does not split the pulsed light. Therefore, the pulsed light polarized in the second direction (P-polarized light) is transmitted directly through the second polarizing beam splitter 23D without being split.

The optical-path-length-difference imparter 22D-2 imparts a second optical-path-length difference between the P-polarized light and the S-polarized light split by the first polarizing beam splitter 21D. For example, the optical-path-length-difference imparter 22D-2 includes a first optical path 24D-2 and a second optical path 25D-2.

The first optical path 24D-2 is a path through which the P-polarized light transmitted through the second polarizing beam splitter 23D propagates until it reaches the first polarizing beam splitter 21D. In other words, the P-polarized light, having been transmitted through the second polarizing beam splitter 23D, propagates along the first optical path 24D-2 and is incident on the first polarizing beam splitter 21D.

The second optical path 25D-2 is a path through which the S-polarized light reflected by the second polarizing beam splitter 23D propagates until it reaches the first polarizing beam splitter 21D. Two mirrors DM2 and a single mirror MD1 are provided in the second optical path 25D-2. The mirrors DM2 are, for example, of a semicircular shape. The S-polarized light split by the second polarizing beam splitter 23D is reflected by the two mirrors DM2 and the single mirror MD1 and is incident on the first polarizing beam splitter 21D. Here, the optical path length of the second optical path 25D-2 is longer than the optical path length of the first optical path 24D-2. Therefore, the optical-path-length-difference imparter 22D-2 can impart a second optical-path-length difference between the P-polarized light and the S-polarized light.

The first polarizing beam splitter 21D forms pulsed light the repetition frequency of which is changed by combining the P-polarized light and the S-polarized light after the second optical-path-length difference is imparted by the optical-path-length-difference imparter 22D-2. When the second optical-path-length difference is imparted between the P-polarized light and the S-polarized light, a time difference of (Tr/4) is imparted between the P-polarized light and the S-polarized light during their propagation to the first polarizing beam splitter 21D.

The roof mirror RM2 has, for example, two reflective surfaces, and bends the pulsed light emitted from the first polarizing beam splitter 21D by 180 degrees by reflecting it twice. The pulsed light bent by the roof mirror RM2 is incident on the pulse converter 15D-3. Thus, the pulsed light incident on the roof mirror RM2 is reflected twice and is then incident on the pulse converter 15D-3 from the roof mirror RM2.

The pulse converter 15D-3 includes an optical unit 20D-3 and a half-wave plate 30D-3. The optical unit 20D-3 includes a first polarizing beam splitter 21D, an optical-path-length-difference imparter 22D-3, and a second polarizing beam splitter 23D. The optical unit 20D-2 is an example of the converter. The half-wave plate 30D-2 is an example of the switcher.

The pulsed light from the roof mirror RM2 is incident on the first polarizing beam splitter 21D via the half-wave plate 30D-3. When the pulsed light incident from the half-wave plate 30D-3 is polarized in the first direction, the first polarizing beam splitter 21D splits it into P-polarized light and S-polarized light. In other words, when the pulsed light incident from the half-wave plate 30D-3 is polarized in the first direction, the first polarizing beam splitter 21D transmits the P-polarized light of the pulsed light and reflects the S-polarized light in a predetermined direction. When the pulsed light incident from the half-wave plate 30D-3 is polarized in a second direction other than the first direction, the first polarizing beam splitter 21D does not split the pulsed light. Therefore, the pulsed light polarized in the second direction (P-polarized light) is transmitted directly through the first polarizing beam splitter 21D without being split.

The optical-path-length-difference imparter 22D-3 imparts a third optical-path-length difference between the P-polarized light and the S-polarized light split by the first polarizing beam splitter 21D-3. For example, the optical-path-length-difference imparter 22D-3 includes a first optical path 24D-3 and a second optical path 25D-3.

The first optical path 24D-3 is a path through which the P-polarized light transmitted through the first polarizing beam splitter 21D propagates until it reaches the second polarizing beam splitter 23D. In other words, the P-polarized light, having been transmitted through the first polarizing beam splitter 21D, propagates along the first optical path 24D-3 and is incident on the second polarizing beam splitter 23D.

The second optical path 25D-3 is a path through which the S-polarized light reflected by the first polarizing beam splitter 21D-3 propagates until it reaches the second polarizing beam splitter 23D. Three mirrors MD2 are provided in the second optical path 25D. The S-polarized light split by the first polarizing beam splitter 21D is reflected by the three mirrors MD2 and is incident on the second polarizing beam splitter 23D. Here, the optical path length of the second optical path 25D-3 is longer than the optical path length of the first optical path 24D-3. Therefore, the optical-path-length-difference imparter 22D-3 can impart the third optical-path-length difference between the P-polarized light and the S-polarized light.

The second polarizing beam splitter 23D forms pulsed light the repetition frequency of which is changed by combining the P-polarized light and the S-polarized light after the third optical-path-length difference is imparted by the optical-path-length-difference imparter 22-3. When the third optical-path-length difference is imparted between the P-polarized light and the S-polarized light, a time difference of (Tr/2) is imparted between the P-polarized light and the S-polarized light.

The first polarizing beam splitter 21D is of a rectangular parallelepiped shape. The pulse converters 15D are stacked in the longitudinal direction (Y direction) of the first polarizing beam splitter 21D. To minimize the GDD caused by the propagation of pulsed light through the first polarizing beam splitter 21D, it is desirable that the dimensions of the first polarizing beam splitter 21D in both the incident and reflection directions of the pulsed light be minimized according to the beam diameter.

The second polarizing beam splitter 23D is of a rectangular parallelepiped shape. The pulse converters 15D are stacked in the longitudinal direction (Y direction) of the second polarizing beam splitter 23D. To minimize the GDD caused by the propagation of pulsed light through the second polarizing beam splitter 23D, it is desirable that the dimensions of the second polarizing beam splitter 23D in both the incident and reflection directions of the pulsed light be minimized according to the beam diameter.

Hereunder, a method for converting a repetition frequency according to the fourth embodiment will be described. When the repetition frequency fr of the pulsed light L1 incident on the optical device 4D is changed to fr×1, the angles θ_{D} of the half-wave plate 30D-1, the half-wave plate 30D-2, and the half-wave plate 30D-3 are all set within the second angular range. Therefore, the pulsed light L1 emitted from the light source 2 is not split by the first polarizing beam splitter 21D. In other words, the optical units 20D-1 through 20D-3 do not cause light splitting or time delay impartation for the pulsed light L1, thus maintaining the repetition frequency fr of the pulsed light L1. Therefore, the pulsed light L1 is output from the optical device 4D as pulsed light L2.

Next, a method for converting a repetition frequency by a factor of 2 will be described. When the repetition frequency fr of the pulsed light L1 incident on the optical device 4D is changed to fr×2, that is, changed by a factor of 2¹ (n=1), the angles θ_{D} of the half-wave plate 30D-1 and the half-wave plate 30D-2 are set within the second angular range. On the other hand, the angle θ_{D} of the half-wave plate 30D-3 is set within the first angular range. In such a case, the pulsed light L1 emitted from the light source 2 is transmitted without being split by either the pulse converter 15D-1 or the pulse converter 15D-2. In other words, the optical unit 20D-1 and the optical unit 20D-2 do not cause light splitting or time delay impartation, and the repetition frequency of the pulsed light emitted from the optical unit 20D-1 and the optical unit 20D-2 maintains the repetition frequency fr of the pulsed light L1 emitted from the light source 2. The polarization state of the pulsed light emitted from the optical unit 20D-1 and the optical unit 20D-2 remains P-polarized as with the pulsed light L1.

However, the pulsed light L1 output from the half-wave plate 30D-3 is linearly polarized at 45°. Therefore, of the pulsed light output from the half-wave plate 30D-3, that is, of the 45° linearly polarized light, the P-polarized light is transmitted through the first polarizing beam splitter 21D, while the S-polarized light is reflected by the first polarizing beam splitter 21D. The P-polarized light, having been transmitted through the first polarizing beam splitter 21D, propagates along the first optical path 24D-3 and is incident on the second polarizing beam splitter 23D. On the other hand, the S-polarized light, having been reflected by the first polarizing beam splitter 21D, propagates along the second optical path 25D-3 and is incident on the second polarizing beam splitter 23D. Here, since the longitudinal direction (Y direction) of the first polarizing beam splitter 21D and the second polarizing beam splitter 23D corresponds to the position of the pulse converter 15D, the S-polarized light traveling along the second optical path 25D-3 can avoid the mirror DM1 and the mirror DM2.

A time difference corresponding to the third optical path difference, that is, a time difference of Tr/2 is imparted between the P-polarized light propagating along the first optical path 24D-3 and the S-polarized light propagating along the second optical path 25D-3. The second polarizing beam splitter 23D, by combining the incident P-polarized light and the S-polarized light, generates pulsed light with a repetition frequency of (fr×2). This pulsed light with the repetition frequency of (fr×2) is output from the optical device 4D as pulsed light L2. That is to say, pulsed light with a pulse interval of (Tr/2) is emitted from the optical device 4D as pulsed light L2.

Next, a method for converting a repetition frequency by a factor of 4 will be described. When the repetition frequency fr of the pulsed light L1 incident on the optical device 4D is changed to fr×4, that is, changed by a factor of 2² (n=2), the angle θ, of the half-wave plate 30D-1 is set within the second angular range. On the other hand, the angle θ_{D} of both the half-wave plate 30D-2 and the half-wave plate 30D-3 is set within the first angular range. In such a case, the pulsed light L1 emitted from the light source 2 is transmitted through the pulse converter 15D-1 without being split. In other words, the optical unit 20D-1 does not cause light splitting or time delay impartation, and the repetition frequency of the pulsed light emitted from the optical unit 20D-1 maintains the repetition frequency fr of the pulsed light L1 emitted from the light source 2. The polarization state of the pulsed light emitted from the optical unit 20D-1 remains P-polarized as with the pulsed light L1.

However, the pulsed light immediately after passing through the half-wave plate 30D-2 becomes linearly polarized at 45°. Therefore, of the pulsed light output from the half-wave plate 30D-2, that is, of the 45° linearly polarized light, the P-polarized light is transmitted through the second polarizing beam splitter 23D, while the S-polarized light is reflected by the second polarizing beam splitter 23D. The P-polarized light, having been transmitted through the second polarizing beam splitter 23D, propagates along the first optical path 24D-2 and is incident on the first polarizing beam splitter 21D. On the other hand, the S-polarized light, having been reflected by the second polarizing beam splitter 23D, propagates along the second optical path 25D-2 and is incident on the first polarizing beam splitter 21D. Here, since the longitudinal direction (Y direction) of the first polarizing beam splitter 21D and the second polarizing beam splitter 23D corresponds to the position of the pulse converter 15D, the S-polarized light traveling along the second optical path 25D-2 can avoid the mirror DM1.

A time difference corresponding to the second optical path difference, that is, a time difference of Tr/4 is imparted between the P-polarized light propagating along the first optical path 24D-2 and the S-polarized light propagating along the second optical path 25D-2. The first polarizing beam splitter 21D, by combining the incident P-polarized light and the S-polarized light, generates pulsed light. The pulsed light generated by the first polarizing beam splitter 21D is incident on the half-wave plate 30D-3. When the pulsed light passes through the half-wave plate 30D-3, the polarization of the transmitted pulsed light becomes linearly polarized at +45° and linearly polarized at −45°, respectively.

Of the temporally leading +45° linearly polarized light, the P-polarized light component is transmitted through the first polarizing beam splitter 21D and propagates along the first optical path 24D-3. Of the +45° linearly polarized light, the S-polarized light component is reflected by the first polarizing beam splitter 21D and propagates along the second optical path 25D-3. Of the −45° linearly polarized light, the P-polarized light component is transmitted through the first polarizing beam splitter 21D and propagates along the first optical path 24D-3. Of the −45° linearly polarized light, the S-polarized light component is reflected by the first polarizing beam splitter 21D and propagates along the second optical path 25D-3. Therefore, a time difference of (Tr/2) is imparted between the P-polarized light propagating along the first optical path 24D-3 and the S-polarized light propagating along the second optical path 25D-3. The second polarizing beam splitter 23D, by combining two incident P-polarized lights and two S-polarized lights, generates pulsed light with a repetition frequency of (fr×4). That is to say, pulsed light with a pulse interval of (Tr/4) is emitted from the optical device 4D as pulsed light L2.

When the repetition frequency fr of the pulsed light L1 incident on the optical device 4D is changed to fr×8, that is, changed by a factor of 23 (n=3), the angles θ_{D} of the half-wave plate 30D-1, the half-wave plate 30D-2, and the half-wave plate 30D-3 are all set within the first angular range.

The pulsed light L immediately after passing through the half-wave plate 30D-1 becomes linearly polarized at 45°. Therefore, of the pulsed light output from the half-wave plate 30D-1, that is, of the 45° linearly polarized light, the P-polarized light component is transmitted through the first polarizing beam splitter 21D, while the S-polarized light component is reflected by the first polarizing beam splitter 21D. The P-polarized light, having been transmitted through the first polarizing beam splitter 21D, propagates along the first optical path 24D-1 and is incident on the second polarizing beam splitter 23D. On the other hand, the S-polarized light, having been reflected by the first polarizing beam splitter 21D, propagates along the second optical path 25D-1 and is incident on the second polarizing beam splitter 23D. Therefore, a time difference corresponding to the first optical path difference, that is, a time difference of Tr/8 is imparted between the P-polarized light propagating along the first optical path 24D-1 and the S-polarized light propagating along the second optical path 25D-1.

The second polarizing beam splitter 23D generates pulsed light by combining the P-polarized light and the S-polarized light to which the first optical path difference is imparted. This pulsed light is incident on the half-wave plate 30D-2 via the roof mirror RM1. Since the angle θ_{D} of the half-wave plate 30D-2 is within the first angular range, the pulsed light, after passing through the half-wave plate 30D-2, is polarized into linearly polarized light at +45° and linearly polarized light at −45°, respectively.

Of the temporally leading +45° linearly polarized light, the P-polarized light component is transmitted through the second polarizing beam splitter 23D and propagates along the first optical path 24D-2. Of the +45° linearly polarized light, the S-polarized light component is reflected by the second polarizing beam splitter 23D and propagates along the second optical path 25D-2. Of the −45° linearly polarized light, the P-polarized light component is transmitted through the second polarizing beam splitter 23D and propagates along the first optical path 24D-2. Of the −45° linearly polarized light, the S-polarized light component is reflected by the second polarizing beam splitter 23D and propagates along the second optical path 25D-2. Therefore, a time difference of (Tr/4) is imparted between the P-polarized light and the S-polarized light, which are split by the second polarizing beam splitter 23D. The first polarizing beam splitter 21D, by combining two incident P-polarized lights and two S-polarized lights, generates pulsed light. The pulsed light generated by the first polarizing beam splitter 21D is incident on the half-wave plate 30D-3 via the roof mirror RM2.

When the pulsed light generated by the first polarizing beam splitter 21D passes through the half-wave plate 30D-3, the polarization of the transmitted pulsed light becomes linearly polarized at 45°, with the P-polarized and S-polarized components orthogonal to each other. In other words, the pulsed light after passing through the half-wave plate 30D-3, the two temporally leading pulses are linearly polarized at +45°, and the two temporally trailing pulses are linearly polarized at −45°.

In each of the two temporally leading +45° linearly polarized lights, the P-polarized light component is transmitted through the first polarizing beam splitter 21D and propagates along the first optical path 24D-3, while the S-polarized light component is reflected by the first polarizing beam splitter 21D and propagates along the second optical path 25D-3. In each of the two temporally trailing −45° linearly polarized lights, the P-polarized light component is transmitted through the first polarizing beam splitter 21D and propagates along the first optical path 24D-3, while the S-polarized light component is reflected by the first polarizing beam splitter 21D and propagates along the second optical path 25D-3. Therefore, a time difference of (Tr/2) is imparted between the P-polarized light propagating along the first optical path 24D-3 and the S-polarized light propagating along the second optical path 25D-3.

The second polarizing beam splitter 23D, by combining four incident P-polarized lights and four S-polarized lights, generates pulsed light with a repetition frequency of (fr×8). That is to say, pulsed light with a pulse interval of (Tr/8) is emitted from the optical device 4D as pulsed light L2.

The flow of the method for converting a repetition frequency (by a factor or 1, or fr×2ⁿ) according to the fourth embodiment, as described below, is the same as that of the first embodiment shown in FIG. 11, and therefore, the description thereof is omitted.

The optical device 4D of the fourth embodiment includes optical units 20D that convert the repetition frequency fr of pulsed light L emitted from the light source 2, and half-wave plates 30D that can change the repetition frequency converted (by a factor of 1, or fr×2ⁿ) by the optical units 20D. With such a configuration, in addition to achieving the same effects as the first embodiment, the number of polarizing beam splitters per optical unit can be reduced by one compared to the first embodiment. Also, compared to the second embodiment, the number of optical elements used in the pulse converter 15D can be reduced, thereby contributing to improved robustness and cost reduction.

### Fifth Embodiment

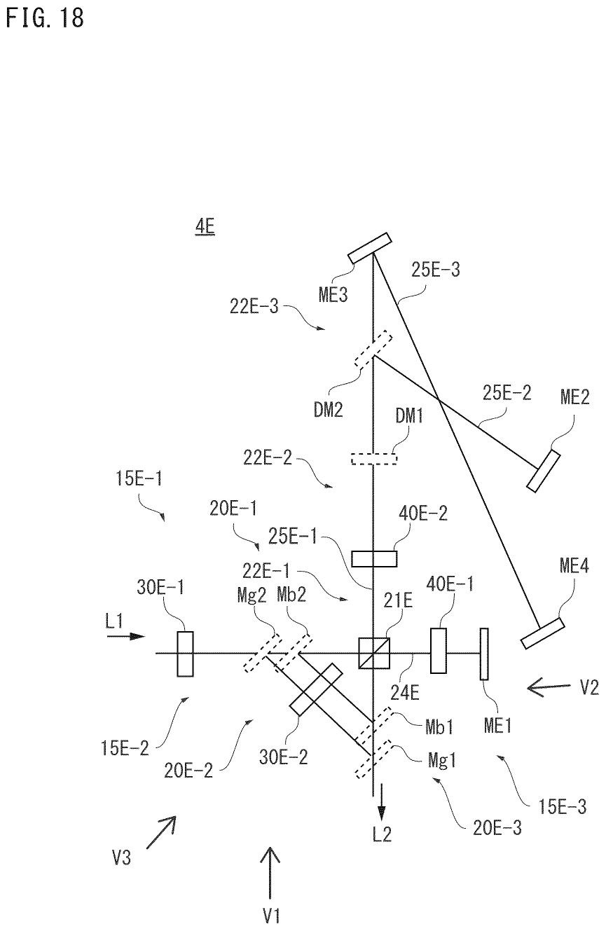

A microscope according to a fifth embodiment is identical to the microscope 1 according to the first embodiment shown in FIG. 1, except that the optical device 4 is replaced with an optical device 4E shown in FIG. 18. The principle of the method for converting a repetition frequency in the optical device 4E according to the fifth embodiment is the same as that of the method for converting a repetition frequency according to the second embodiment. The optical device 4E has a configuration equivalent to that of the optical device 4A of the second embodiment, however, it differs from the second embodiment in that it employs common polarizing beam splitters and quarter-wave plates included in the multiple pulse converters.

The optical device 4E is capable of converting the repetition frequency fr of pulsed light L1 emitted from the light source 2 to a repetition frequency different from the repetition frequency fr. For example, the optical device 4E converts the repetition frequency fr by a maximum factor of 2ⁿ (where n is an integer greater than or equal to one). The optical device 4E splits pulsed light into P-polarized light and S-polarized light orthogonal to the P-polarized light, imparts a predetermined optical-path-length difference between the P-polarized light and the S-polarized light, and then combines the P-polarized light and the S-polarized light after imparting the optical-path-length difference. This series of processes is performed n iterations (where n is an integer from 1 through n), thereby converting the repetition frequency by a factor of 2ⁿ. The optical device 4E may be configured to be removably inserted in the microscope 1.

FIG. 18 is a diagram showing a configuration example of the optical device 4E according to the fifth embodiment. The optical device 4E exemplified in FIG. 18 includes three pulse converters 15E-1 through 15E-3.

The pulse converter 15E-1 includes an optical unit 20E-1 and a half-wave plate 30E-1. The optical unit 20E-1 includes a polarizing beam splitter 21E and an optical-path-length-difference imparter 22E-1. The optical unit 20E-1 is an example of the converter. The half-wave plate 30E-1 is an example of the switcher.

The pulse converter 15E-2 includes an optical unit 20E-2 and a half-wave plate 30E-2. The optical unit 20E-2 includes a polarizing beam splitter 21E, mirrors Mb1, Mb1, and an optical-path-length-difference imparter 22E-2. The optical unit 20E-2 is an example of the converter. The half-wave plate 30E-2 is an example of the switcher.

The pulse converter 15E-3 includes an optical unit 20E-3 and a half-wave plate 30E-3. The optical unit 20E-3 includes a polarizing beam splitter 21E, mirrors Mg1, Mg2, and an optical-path-length-difference imparter 22E-3. The optical unit 20E-3 is an example of the converter.

The polarizing beam splitter 21E splits pulsed light polarized in a first direction into P-polarized light and S-polarized light. When the incident pulsed light is polarized in the first direction, the polarizing beam splitter 21E transmits the P-polarized light of the pulsed light and reflects the S-polarized light of the pulsed light in a predetermined direction. When the incident pulsed light is polarized in a second direction other than the first direction, the polarizing beam splitter 21E does not split the pulsed light. Therefore, the pulsed light polarized in the second direction (P-polarized light) is transmitted directly through the polarizing beam splitter 21E without being split.

The polarizing beam splitter 21E forms pulsed light the repetition frequency of which is changed by combining the P-polarized light and the S-polarized light after an optical-path-length difference is imparted. In the pulse converters 15E-1 through 15E-3, the polarizing beam splitter that splits pulsed light into P polarized light and S polarized light and combines the P polarized light and S polarized light to which an optical path difference has been imparted is commonly implemented as the polarizing beam splitter 21E. For example, the polarizing beam splitter 21E is of a rectangular parallelepiped shape. The pulse converters 15E are stacked in the longitudinal direction of the polarizing beam splitter 21E.

The optical-path-length-difference imparter 22E-1 imparts a first optical-path-length difference between the P-polarized light and the S-polarized light split by the polarizing beam splitter 21E. This first optical-path-length difference imparts a time difference of (Tr/8) between the P-polarized light and the S-polarized light. For example, the optical-path-length-difference imparter 22E-1 includes a first optical path 24E and a second optical path 25E-1.

The first optical path 24E is a path through which the P-polarized pulsed light transmitted through the polarizing beam splitter 21E propagates. A quarter-wave plate 40E-1 and a mirror ME1 are provided in the first optical path 24E. The P-polarized pulsed light transmitted through the polarizing beam splitter 21E is converted into circularly polarized light by the quarter-wave plate 40E-1. The circularly polarized light converted by the quarter-wave plate 40E-1 is reflected by the mirror ME1 and is incident on the quarter-wave plate 40-1 again. The circularly polarized light reflected by the mirror ME1 and incident on the quarter-wave plate 40-1 is converted into S-polarized pulsed light and is incident on the polarizing beam splitter 21E.

The second optical path 25E-1 is a path through which the S-polarized light reflected by the polarizing beam splitter 21E propagates until it reaches the polarizing beam splitter 21E. A quarter-wave plate 40E-2 and a mirror DM1 are provided in the second optical path 25E-1. The S-polarized light split by the polarizing beam splitter 21E is converted into circularly polarized light by the quarter-wave plate 40E-2. The circularly polarized light converted by the quarter-wave plate 40E-2 is reflected by the mirror DM1 and is incident on the quarter-wave plate 40E-2 again. The circularly polarized light reflected by the mirror DM1 and incident on the quarter-wave plate 40-2 is converted into P-polarized pulsed light and is incident on the polarizing beam splitter 21E. Here, the optical path length of the second optical path 25E-1 is longer than the optical path length of the first optical path 24E-1. Therefore, the optical-path-length-difference imparter 22E-1 can impart the first optical-path-length difference between the P-polarized light and the S-polarized light.

The mirror Mb1 reflects the pulsed light emitted from the polarizing beam splitter 21E toward the mirror Mb2. The mirror Mb2 is arranged at a higher position than the mirror Mb1. Therefore, the mirror Mb1 reflects the incident pulsed light toward the mirror Mb2 arranged obliquely above it, for example. The mirror Mb2 reflects the pulsed light from the mirror Mb1, after it has passed through the half-wave plate 30E-2, toward the polarizing beam splitter 21E.

The optical-path-length-difference imparter 22E-2 imparts a second optical-path-length difference between the P-polarized light and the S-polarized light of the pulsed light split by the polarizing beam splitter 21E. This second optical-path-length difference imparts a time difference of (Tr/4) between the P-polarized light and the S-polarized light. For example, the optical-path-length-difference imparter 22E-1 includes a first optical path 24E and a second optical path 25E-2.

The second optical path 25E-2 is a path through which the S-polarized light of the pulsed light reflected by the polarizing beam splitter 21E propagates until it reaches the polarizing beam splitter 21E. A quarter-wave plate 40E-2, a mirror DM2, and a mirror ME2 are provided in the second optical path 25E-2. The S-polarized light propagating along the second optical path 25E-2 is converted into circularly polarized light by the quarter-wave plate 40E-2. This circularly polarized light is reflected by the mirror DM2 and travels toward the mirror ME2. The circularly polarized light traveling toward the mirror ME2 is reflected by the mirror ME2, returns to the mirror DM2, and is reflected by the mirror DM2 to be incident on the quarter-wave plate 40E-2. The circularly polarized light reflected by the mirror DM2 and incident on the quarter-wave plate 40E-2 is converted into P-polarized pulsed light and is incident on the polarizing beam splitter 21E. Here, the optical path length of the second optical path 25E-2 is longer than the optical path length of the second optical path 25E-1. Therefore, the optical-path-length-difference imparter 22E-2 can impart the second optical-path-length difference, greater than the first optical path difference, between the P-polarized light and S-polarized light.

The mirror Mg1 is arranged at a higher position than the mirror Mb1. The mirror Mg1 reflects the pulsed light emitted from the polarizing beam splitter 21E toward the mirror Mg2. The mirror M2g is arranged at a higher position than the mirror Mb2. The mirror Mg2 is arranged at a higher position than the mirror Mlg. The mirror Mg1 reflects the incident pulsed light toward the mirror M2g arranged obliquely above it, for example. The mirror Mg2 reflects the pulsed light from the mirror Mg1, after it has passed through the half-wave plate 30E-2, toward the polarizing beam splitter 21E.

The optical-path-length-difference imparter 22E-3 imparts a third optical-path-length difference between the P-polarized light and the S-polarized light of the pulsed light from the mirror Mg2 split by the polarizing beam splitter 21E. This third optical-path-length difference imparts a time difference of (Tr/2) between the P-polarized light and the S-polarized light. For example, the optical-path-length-difference imparter 22E-1 includes a first optical path 24E and a second optical path 25E-3.

The second optical path 25E-3 is a path through which the S-polarized light of the pulsed light reflected by the polarizing beam splitter 21E propagates until it reaches the polarizing beam splitter 21E. A quarter-wave plate 40E-2, a mirror ME3, and a mirror ME4 are provided in the second optical path 25E-3. The S-polarized light propagating along the second optical path 25E-3 is converted into circularly polarized light by the quarter-wave plate 40E-2. This circularly polarized light is reflected by the mirror ME3 and travels toward the mirror ME4. The circularly polarized light traveling toward the mirror ME4 is reflected by the mirror ME4, returns to the mirror ME3, and is reflected by the mirror ME3 to be incident on the quarter-wave plate 40E-2. The circularly polarized light reflected by the mirror ME3 and incident on the quarter-wave plate 40E-2 is converted into P-polarized pulsed light and is incident on the polarizing beam splitter 21E. Here, the optical path length of the second optical path 25E-3 is longer than the optical path length of the second optical path 25E-2. Therefore, the optical-path-length-difference imparter 22E-2 can impart the third optical-path-length difference, longer than the second optical path difference, between the P-polarized light and S-polarized light.

The half-wave plate 30E-2 changes the polarization direction of the pulsed light incident on the polarizing beam splitter 21E to either the first direction or the second direction, which is different from the first direction. The half-wave plate 30E-1 is rotatable. By rotating the half-wave plate 30E-1, the angle θ_{E} of the half-wave plate 30E-1 is changed. For example, rotating the half-wave plate 30E-1 allows switching between a first state where the angle θ_{E} of the half-wave plate 30E-1 is within a first angular range, and a second state where the angle θ_{E} is within a second angular range. When the angle θ_{E} of the half-wave plate 30E-1 is within the first angular range, the pulsed light in the first direction is emitted from the half-wave plate 30E-1. When the angle θ_{E} of the half-wave plate 30E-1 is within the second angular range, different from the first angular range, the pulsed light in the second direction, different from the first direction, is emitted from the half-wave plate 30E-1.

The half-wave plate 30E-2 changes the direction of the pulsed light reflected by the mirror Mb1 to either the first direction or the second direction different from the first direction. The half-wave plate 30E-2 changes the direction of the pulsed light reflected by the mirror Mg1 to either the first direction or the second direction different from the first direction. The half-wave plate 30E-2 is rotatable. By rotating the half-wave plate 30E-2, the angle θ_{E} of the half-wave plate 30E-2 is changed. For example, rotating the half-wave plate 30E-2 allows switching between a first state where the angle θ_{E} of the half-wave plate 30E-2 is within the first angular range, and a second state where the angle θ_{E} is within the second angular range. When the angle θ_{E} of the half-wave plate 30E-2 is within the first angular range, the pulsed light in the first direction is emitted from the half-wave plate 30E-2. When the angle θ_{E} of the half-wave plate 30E-2 is within the second angular range, different from the first angular range, the pulsed light in the second direction, different from the first direction, is emitted from the half-wave plate 30E-2.

Hereunder, a method for converting a repetition frequency according to the fifth embodiment will be described. When the repetition frequency fr of the pulsed light L1 incident on the optical device 4E is changed to fr×1, the angles θ_{E} of the half-wave plate 30E-1 and the half-wave plate 30E-2 are both set within the second angular range. Therefore, the pulsed light L1 emitted from the light source 2 is transmitted through the polarizing beam splitter 21E without being split. That is to say, the optical units 20E-1 through 20E-3 do not cause light splitting or time delay impartation for the pulsed light L1, thus maintaining the repetition frequency fr of the pulsed light L1. In other words, the pulsed light L1 is output from the optical device 4E as pulsed light L2.

The optical device 4E according to the fifth embodiment can vary the repetition frequency fr of the pulsed light L1 emitted from the light source 2 to one of three repetition frequencies, namely, fr×1, fr×4, and fr×8, by controlling the rotation of the half-wave plates 30E-1, 30E-2. Since the common ½ wavelength plate 30E-2 is employed, the repetition frequency cannot be changed to fr×2. For example, by setting the angle θ_{E} of the half-wave plate 30E-1 within the second angular range and setting the angle θ_{E} of the half-wave plate 30E-2 within the second angular range (for example, 0° relative to S-polarization), pulsed light with a repetition frequency of (fr×1) can be output from the optical device 4E.

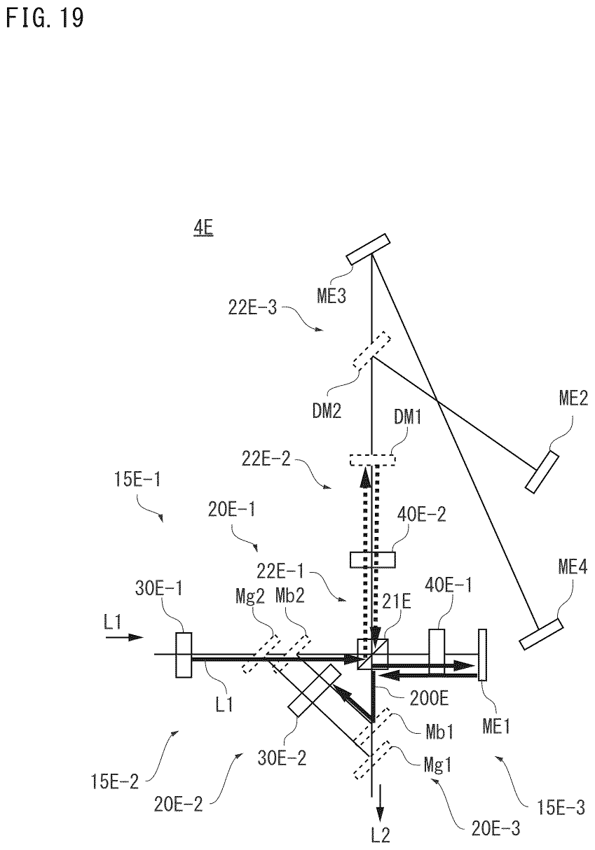

For example, by setting the angle θ_{E} of the half-wave plate 30E-1 within the second angular range and setting the angle θ_{E} of the half-wave plate 30E-2 within the first angular range, pulsed light with a repetition frequency of (fr×4) can be output from the optical device 4E. Hereinafter, a method for converting a repetition frequency by a factor of 8 will be described, with reference to FIG. 19 through FIGS. 22A to 22H.

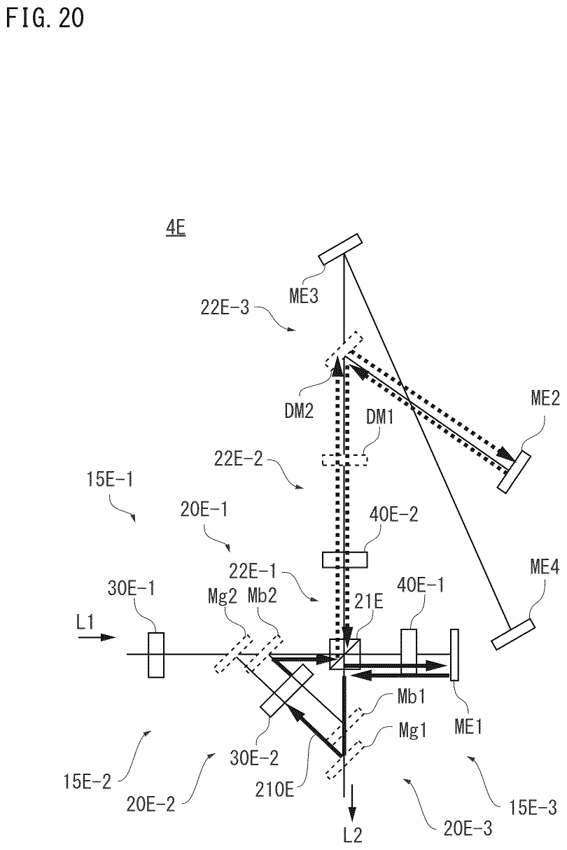

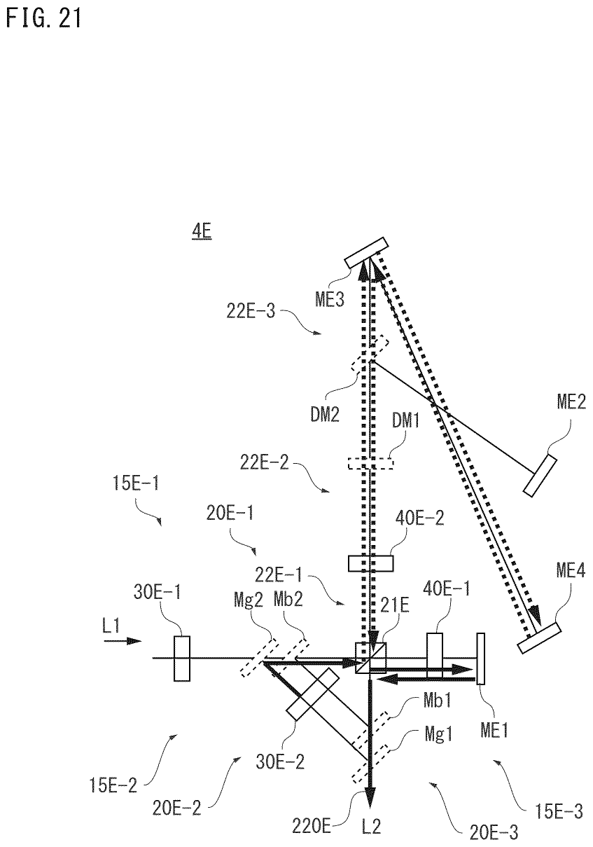

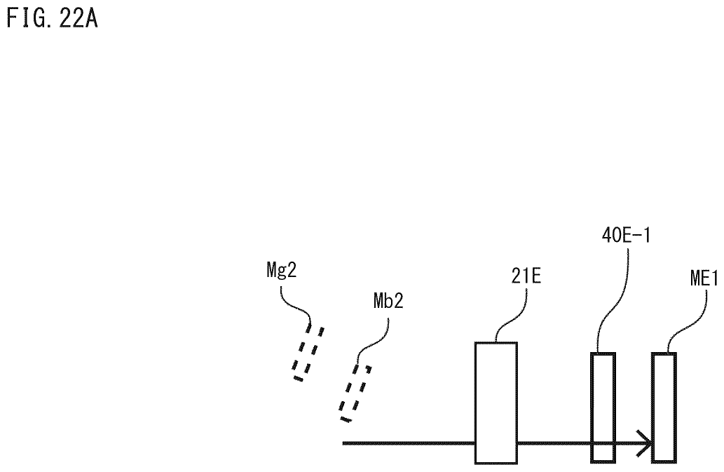

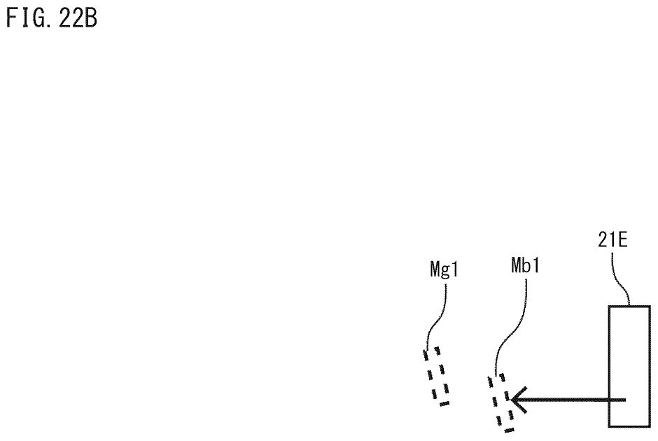

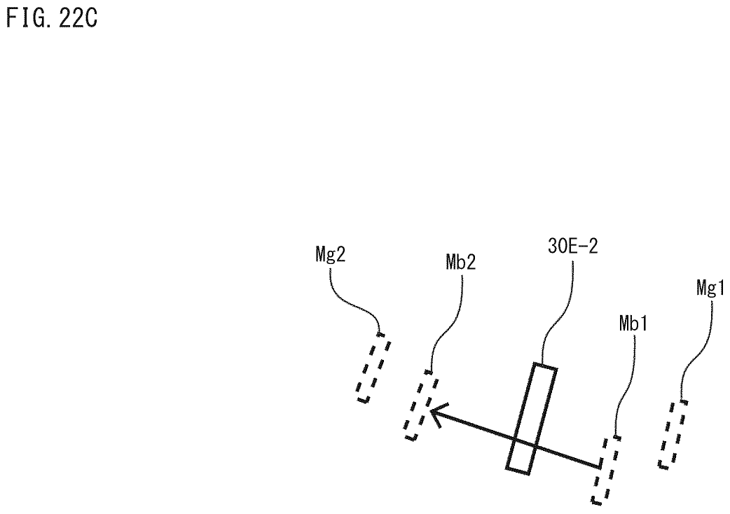

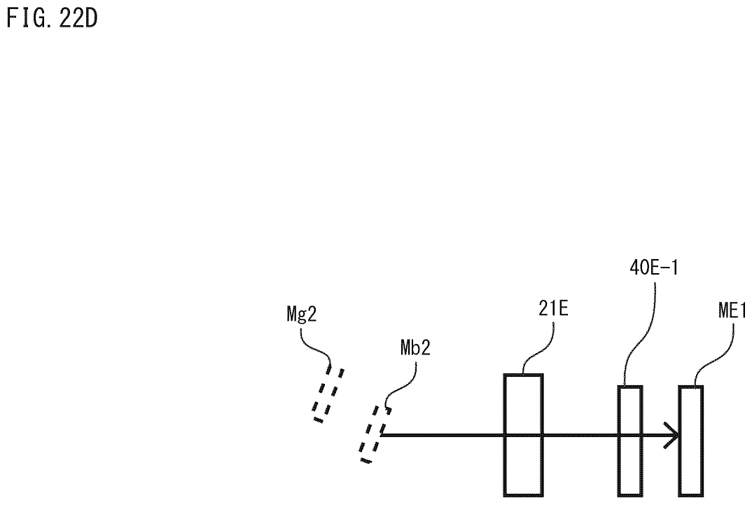

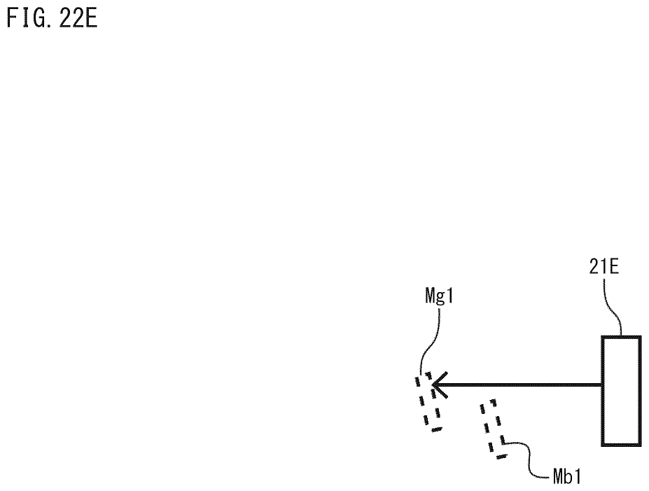

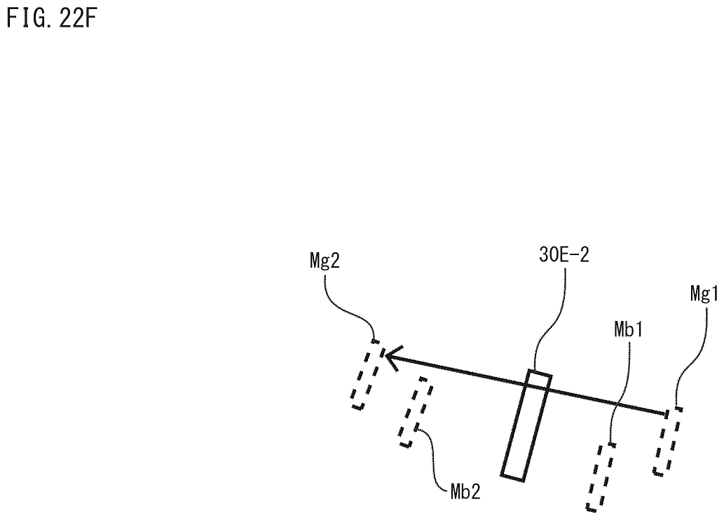

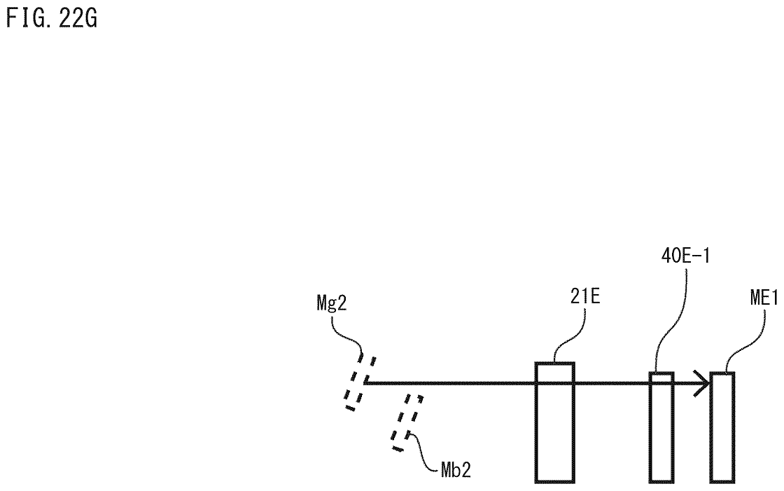

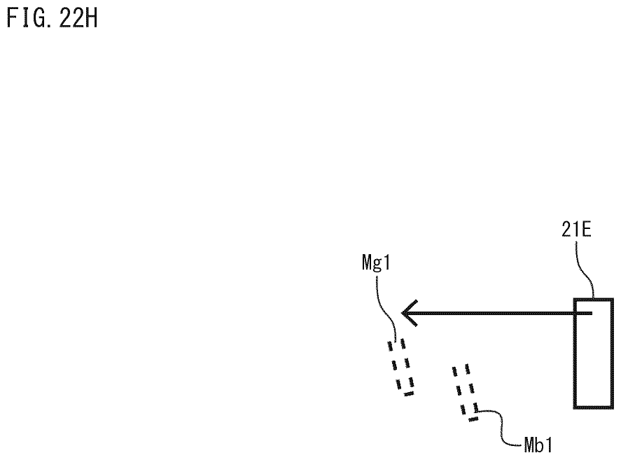

FIG. 19 through FIGS. 22A to 22H are diagrams for describing the method for converting a repetition frequency by a factor of 8. FIG. 19 is a diagram for describing the optical path in the pulse converter 15E-1. FIG. 20 is a diagram for describing the optical path in the pulse converter 15E-2. FIG. 21 is a diagram for describing the optical path in the pulse converter 15E-3. FIGS. 22A to 22H are diagrams showing the state of the optical path in each pulse converter according to the fifth embodiment. FIG. 22A, FIG. 22D, and FIG. 22G are views from the orientation of V1 indicated by the arrow in FIG. 18. FIG. 22B, FIG. 22E, and FIG. 22H are views from the orientation of V2 indicated by the arrow in FIGS. 22A to 22H. FIG. 22C and FIG. 22F are views from the orientation of V3 indicated by the arrow in FIG. 18.

When the repetition frequency fr of the pulsed light L1 incident on the optical device 4E is changed to fr×8, that is, changed by a factor of 23 (n=3), the angles θ_{E} of the half-wave plate 30E-1 and the half-wave plate 30E-2 are set within the first angular range.

The pulsed light immediately after passing through the half-wave plate 30E-1 becomes linearly polarized at 45°. Therefore, of the pulsed light output from the half-wave plate 30E-1, that is, of the 45° linearly polarized light, the P-polarized light component is transmitted through the polarizing beam splitter 21E, while the S-polarized light component is reflected by the polarizing beam splitter 21E. The P-polarized light, having been transmitted through the polarizing beam splitter 21E, propagates along the first optical path 24E. Specifically, the P-polarized light is converted into circularly polarized light by the quarter-wave plate 40E-1 (FIG. 22A). The circularly polarized light converted by the quarter-wave plate 40E-1 is regularly reflected by the mirror ME1 and is incident on the quarter-wave plate 40E-1 again to be converted into S-polarized light.

The S-polarized light, having been reflected by the polarizing beam splitter 21E, propagates along the second optical path 25-1. Specifically, the S-polarized light is converted into circularly polarized light by the quarter-wave plate 40E-2. Then, the circularly polarized light is regularly reflected by the mirror DM1 and is incident on the quarter-wave plate 40-2 again to be converted into P-polarized light. Thus, as shown in FIG. 19, the polarizing beam splitter 21E generates pulsed light 200E by combining the S-polarized light from the quarter-wave plate 40E-1 and the P-polarized light from the quarter-wave plate 40E-2. In other words, by coaxially combining the pulses from both optical paths using the polarizing beam splitter 21E, two pulses (pulsed light) to which a time difference of Tr/8 is imparted are obtained, similar to the emitted light of the pulse converter 15-1 exemplified in FIG. 10. This pulsed light travels toward the mirror Mb1 (FIG. 22B). In other words, the S-polarized light from the quarter-wave plate 40E-1 is reflected by the polarizing beam splitter 21E and travels toward the mirror Mb1. The P-polarized light from the quarter-wave plate 40E-2 is transmitted through the polarizing beam splitter 21E and travels toward the mirror Mb1.

The pulsed light 200E is reflected by the mirror Mb1 to be incident on the half-wave plate 30E-2 (FIG. 22C). Here, the reflection at the mirror Mb1 increases the height of the optical path along which the pulsed light 200E travels. When the pulsed light 200E is incident on the half-wave plate 30E-2, the polarization directions of the S-polarized light and P-polarized light are both rotated by 45°. The pulsed light 200E, after passing through the half-wave plate 30E-2, is reflected by the mirror Mb2 and is incident on the polarizing beam splitter 21E.

Each of the two pulses of the pulsed light 200E has a P-polarized component and an S-polarized component. As shown in FIG. 20, in each of the two pulses incident on the polarizing beam splitter 21E, the S-polarized component is reflected by the polarizing beam splitter 21E and its polarization state is changed to circularly polarized by the quarter-wave plate 40E-2. This circularly polarized light is reflected by the mirror DM2 and travels toward the mirror ME2. The light regularly reflected by the mirror ME2 is reflected again by the mirror DM2 and passes through the quarter-wave plate 40E-2 again, whereby it is converted into P-polarized light. This P-polarized light is incident on the polarizing beam splitter 21E.

In each of the two pulses incident on the polarizing beam splitter 21E, the P-polarized component is transmitted through the polarizing beam splitter 21E and its polarization state is changed to circularly polarized by the quarter-wave plate 40E-1 (FIG. 22D). This circularly polarized light is reflected by the mirror ME1 and is incident on the quarter-wave plate 40E-1 again, whereby its polarization state becomes S-polarized. This S-polarized light is incident on the polarizing beam splitter 21E.

The polarizing beam splitter 21E generates pulsed light 210E by combining the S-polarized light from the quarter-wave plate 40E-1 and the P-polarized light from the quarter-wave plate 40E-2. In other words, two pulses with a time difference of Tr/4 imparted thereto are generated from one pulse. Thus, by coaxially combining the pulses from both optical paths using the polarizing beam splitter 21E, four pulses, as shown with the emitted light of the pulse converter 15-2 exemplified in FIG. 10, are obtained. This pulsed light 210E travels toward the mirror Mg1 (FIG. 22E). In other words, the S-polarized light from the quarter-wave plate 40E-1 is reflected by the polarizing beam splitter 21E and travels toward the mirror Mg1. The P-polarized light from the quarter-wave plate 40E-2 is transmitted through the polarizing beam splitter 21E and travels toward the mirror Mg1.

The pulsed light 210E is reflected by the mirror Mg1 to be incident on the half-wave plate 30E-2. Here, the reflection at the mirror Mg1 increases the height of the optical path along which the pulsed light 210E travels (FIG. 22F). When the pulsed light 210E is incident on the half-wave plate 30E-2, the polarization directions of the S-polarized light and P-polarized light are both rotated by 45°. The pulsed light 210E, after passing through the half-wave plate 30E-2, is reflected by the mirror Mg2 and is incident on the polarizing beam splitter 21E.

Each of the four pulses of the pulsed light 210E has a P-polarized component and an S-polarized component. As shown in FIG. 21, in each of the four pulses incident on the polarizing beam splitter 21E, the S-polarized component is reflected by the polarizing beam splitter 21E and its polarization state is changed to circularly polarized by the quarter-wave plate 40E-2 (FIG. 22G). This circularly polarized light is reflected by the mirror ME3 and travels toward the mirror ME4. The light regularly reflected by the mirror ME4 is reflected again by the mirror ME3 and is transmitted through the quarter-wave plate 40E-2, whereby it is converted into P-polarized light. This P-polarized light is incident on the polarizing beam splitter 21E.

In each of the four pulses incident on the polarizing beam splitter 21E, the P-polarized component is transmitted through the polarizing beam splitter 21E and its polarization state is changed to circularly polarized by the quarter-wave plate 40E-1. This circularly polarized light is reflected by the mirror ME1 and is incident on the quarter-wave plate 40E-1 again, whereby its polarization state becomes S-polarized. This S-polarized light is incident on the polarizing beam splitter 21E.

The polarizing beam splitter 21E generates pulsed light 220E by combining the S-polarized light from the quarter-wave plate 40E-1 and the P-polarized light from the quarter-wave plate 40E-2. In other words, two pulses with a time difference of Tr/2 imparted thereto are generated from one pulse. Thus, by coaxially combining the pulses from both optical paths using the polarizing beam splitter 21E, eight pulses, as shown with the emitted light of the pulse converter 15-3 of FIG. 10, are obtained. The pulsed light 220E is emitted from the optical device 4E as pulsed light L2 (FIG. 22H). In the fifth embodiment, the position of the pulsed light passing through the quarter-wave plate 40E-2 is controlled by using the mirrors Mb1, Mb2, Mg1, and Mg2. Thereby, it is possible to reduce the number of quarter-wave plates used for converting the repeating frequency.

The controller 11 controls the rotation of the half-wave plate 30E-1 and the half-wave plate 30E-2. The controller 11 may control the rotation of each of the quarter-wave plate 40E-1 and the quarter-wave plate 40E-2.

The flow of the method for converting a repetition frequency (by a factor or 1, or fr×2ⁿ) according to the fifth embodiment, as described below, is the same as that of the first embodiment shown in FIG. 11, and therefore, the description thereof is omitted.

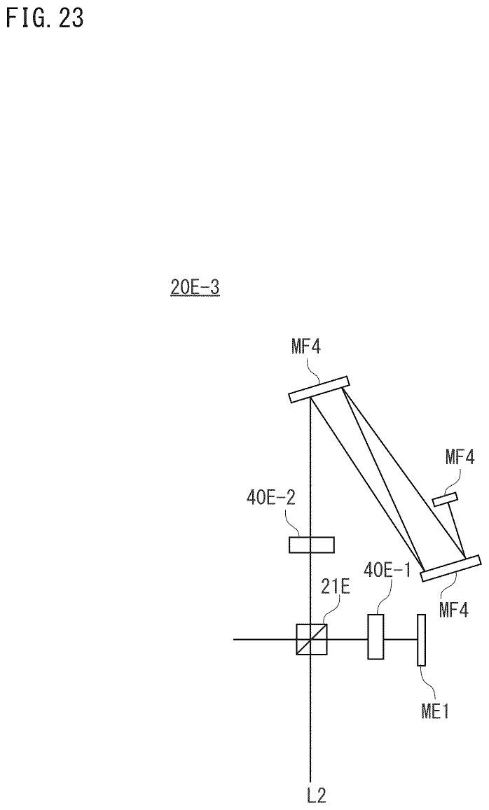

FIG. 23 is a diagram showing a modified example of the optical unit 20E-3 in the optical device 4E. An optical-path-length-difference imparter 22F-3 of an optical unit 20F-3 of the modified example, as shown in FIG. 23, includes a first optical path 24F and a second optical path 25F-3. The first optical path 24F is similar to the first optical path 24E. Multiple mirrors MF4 are provided in the second optical path 25F-3. Pulsed light is reflected multiple times in the second optical path 25F-3 by using the multiple mirrors MF4. Such a configuration enables the optical device 4F to reduce the size required to impart a third optical-path-length difference. It is preferable to use mirrors MF with the highest possible reflectance. This makes it possible to suppress a reduction in light intensity caused by the influence of mirror reflectance.

The optical device 4E of the fifth embodiment includes optical units 20E that convert the repetition frequency fr of pulsed light L emitted from the light source 2, and half-wave plates 30E that can change the repetition frequency converted (by a factor of 1, or fr×2ⁿ) by the optical units 20E. Such a configuration, in addition to achieving the same effects as the first embodiment, contributes to improved robustness and cost reduction by implementing common multiple half-wave plates, multiple polarizing beam splitters, and multiple quarter-wave plates.

The optical device of any one of the first through fifth embodiments may output circularly polarized pulsed light L2 to the light emitter. In such a case, the optical device may have a quarter-wave plate to circularly polarize the pulsed light L2 output from the pulse converter of the final stage among the multiple pulse converters connected in multiple stages. In other words, a quarter-wave plate may be connected to the subsequent stage of the pulse converter of the final stage. By using circularly polarized pulsed light L2, an isotropic PSF can be obtained with a high-NA objective lens.

In the optical device of any one of the first through fifth embodiments, the pulsed light L2 may be linearly polarized in the same direction. In such a case, a polarizer may be installed in the subsequent stage of the pulse converter of the final stage. For example, by setting the transmission axis of the polarizer at 45° relative to two orthogonal linearly polarized lights, the polarization direction of the light transmitted through the polarizer can be made linearly polarized in the same direction. However, the polarizer reduces the average optical power by half. To change the polarization direction of linearly polarized light, a half-wave plate may be installed in the subsequent stage of the polarizer. When the transmission axis of the polarizer is parallel to one of the two orthogonal linearly polarized lights, only the S-polarized light or P-polarized light of the pulsed light can be extracted.

Here, the pulse width of the ultrashort pulse can be broadened due to the dispersion of optical elements. This may result in a decrease in the peak intensity of the pulsed light, and a decrease in the efficiency of signal generation caused by nonlinear effects. To efficiently generate nonlinear signals, dispersion compensation is generally employed. As a dispersion compensation method, a diffraction grating pair or a prism pair is used. It is preferable to install a dispersion compensation optical system including such an element between the light source 2 and the optical device of any one of the first through fifth embodiments. However, the invention is not limited to this example, the dispersion compensation optical system may be provided between the light emitter 3 and the optical device of any one of the first through fifth embodiments. In the case where the light source 2 including dispersion compensation optics is used, an additional dispersion compensation optical system is not required.

The scanner of a microscope incorporating the optical device of any one of the first through fifth embodiments may have either a pair of galvanometer mirrors or a galvanometer mirror paired with a resonant mirror. The former is referred to as galvano scanning, and the latter is referred to as resonant scanning. Under the condition that the intensity of the laser light is the same, the resonant scanning is less likely to cause photobleaching than the galvano scanning because the scanning speed of resonant scanning is faster and the laser light emission time is shorter. Within the time required for galvano scanning to acquire a single image, resonant scanning can acquire several tens of times more images. For example, 30 images can be acquired. By integrating these 30 images, an image with image quality (signal-to-noise ratio) equivalent to that of galvano scanning can be obtained. Even under conditions yielding comparable image quality, resonant scanning results in a shorter laser-light-emission time per unit area per image and intermittent laser light emission, thereby reducing photobleaching compared to galvano scanning. The application of the present invention to resonant scanning provides a reduction in photobleaching compared to its application to galvano scanning.

In a microscope incorporating the optical device of any one of the first through fifth embodiments, when increasing the repetition frequency by a factor of n, it is preferable to set the average power of pulsed light L1 (L2) to √n (W). In such a case, the peak intensity (W) of the pulsed light L2 is multiplied by a factor of 1/√n. This allows for the acquisition of two-photon fluorescence images with equivalent image quality, independent of the repetition frequency. A mechanism for automatically controlling and setting the light intensity in response to changes in the repetition frequency may be provided.

The embodiments of the invention have been described above. However, the technical scope of the present disclosure is not limited to the modes described in the above embodiments. One or more of the requirements described in the above embodiments may be omitted in some cases. One or more of the requirements described in the above embodiments may be combined where appropriate. Furthermore, the contents of all documents cited in the detailed description of the present invention are incorporated herein by reference to the extent permitted by law.

### DESCRIPTION OF REFERENCE SIGNS

1, 1A-1E: Microscope
2: Light source
4, 4A-4E: Optical device
11: Controller
12: Setter
15, 15A-15F: Pulse converter
20, 20A-20F: Optical unit
30, 30A-30E: Half-wave plate
40B, 41B, 40E: Quarter-wave plate

1.-37. (canceled)

38. A conversion method comprising
converting a repetition frequency of pulsed light emitted from a light source by a converter, and
allowing the repetition frequency converted by the converter to be variable,
wherein the conversion of the repetition frequency by the converter includes
a first stage for changing a polarization direction of the pulsed light to a first direction via a half-wave plate,
a second stage for splitting the pulsed light polarized in the first direction into a first polarized light and a second polarized light orthogonal to the first polarized light,
a third stage for imparting a predetermined optical-path-length difference between the first polarized light and the second polarized light, and
a fourth stage for generating the pulsed light the repetition frequency of which is changed by combining the first polarized light and the second polarized light after the impartation of the predetermined optical-path-length difference,
wherein the converter converts the repetition frequency by a factor of 2ⁿ (where n is an integer greater than or equal to one) by executing n iterations a series of processes including the first stage, the second stage, the third stage, and the fourth stage, and
wherein, among the n iterations, the second stage of an odd-numbered iteration and the fourth stage of an even-numbered iteration are performed by a first polarizing beam splitter, and the fourth stage of the odd-numbered iteration and the second stage of the even-numbered iteration are performed by a second polarizing beam splitter different from the first polarizing beam splitter.

39. A conversion method comprising
converting a repetition frequency of pulsed light emitted from a light source by a converter, and
allowing the repetition frequency converted by the converter to be variable,
wherein the conversion of the repetition frequency by the converter includes
a first stage for changing a polarization direction of the pulsed light to a first direction via a half-wave plate,
a second stage for splitting the pulsed light polarized in the first direction into a first polarized light and a second polarized light orthogonal to the first polarized light,
a third stage for imparting a predetermined optical-path-length difference between the first polarized light and the second polarized light, and
a fourth stage for generating the pulsed light the repetition frequency of which is changed by combining the first polarized light and the second polarized light after the impartation of the predetermined optical-path-length difference,
wherein the converter converts the repetition frequency by a factor of 2ⁿ (where n is an integer greater than or equal to one) by executing n iterations a series of processes including the first stage, the second stage, the third stage, and the fourth stage,
wherein the second stage and the fourth stage are performed by a single polarizing beam splitter,
wherein the first polarized light is P-polarized light, and the second polarized light is S-polarized light,
wherein a first quarter-wave plate is installed in an optical path of the P-polarized light, and a second quarter-wave plate is installed in an optical path of the S-polarized light,
wherein, in the third stage, the P-polarized light passes through the first quarter-wave plate twice, and the S-polarized light passes through the second quarter-wave plate twice, and
wherein, a position at which the P-polarized light passes through the first quarter-wave plate in the third stage in each iteration of the n iterations differs from that in other iteration, and a position at which the S-polarized light passes through the second quarter-wave plate in the third stage in each iteration of the n iterations differs from that in other iteration.

40. The conversion method according to claim 38,
wherein, when an angle formed by the polarization direction of the pulsed light incident on the half-wave plate and a slow axis or a fast axis of the half-wave plate falls within a first angular range, the pulsed light in the first direction is emitted from the half-wave plate, and the first stage is performed, and when the angle falls within a second angular range different from the first angular range, the pulsed light in a second direction, different from the first direction, is emitted from the half-wave plate, and the first stage is not performed, and
wherein a change to a factor of 1 or a value of n is performed by switching between a first state, in which the angle formed falls within the first angular range, and a second state, in which the angle formed falls within the second angular range.

41. The conversion method according to claim 40,
wherein the first angular range is a range of) (22.5°±K×45°±1° (where K is an integer).

42. The conversion method according to claim 40,
wherein the second angular range is a range of) (0°±K×90°±1° (where K is an integer).

43. The conversion method according to claim 40,
wherein the half-wave plate is rotatable, and
wherein the angle formed is changed by rotation of the half-wave plate.

44. The conversion method according to claim 38,
wherein, given that a repetition period of the pulsed light emitted from the light source is Tr, when the optical-path-length difference is imparted, a time difference of Tr/2ⁿ is imparted between the first polarized light and the second polarized light.

45. An optical device comprising
a converter that converts a repetition frequency of a pulsed light by a factor of 2ⁿ (where n is an integer greater than or equal to one), and
a switcher capable of changing the repetition frequency converted by the converter,
wherein the converter includes n units of optical units,
wherein the optical unit includes
a first polarizing beam splitter that splits the pulsed light polarized in the first direction into a first polarized light and a second polarized light orthogonal to the first polarized light,
an optical-path-length-difference imparter that imparts a predetermined optical-path-length difference between the first polarized light and the second polarized light, and
a second polarizing beam splitter that forms the pulsed light the repetition frequency of which is changed by combining the first polarized light and the second polarized light after impartation of the predetermined optical-path-length difference, and
wherein the switcher changes the polarization direction of the pulsed light incident on the first polarizing beam splitter to either the first direction or a second direction different from the first direction, and
wherein a single polarizing beam splitter is used as, among the n units of the optical units, the first polarizing beam splitter that is odd-numbered and the second polarizing beam splitter that is even-numbered.

46. An optical device comprising
a converter that converts a repetition frequency of a pulsed light by a factor of 2ⁿ (where n is an integer greater than or equal to one), and
a switcher capable of changing the repetition frequency converted by the converter,
wherein the converter includes n units of optical units,
wherein the optical unit includes
a first polarizing beam splitter that splits the pulsed light polarized in the first direction into a first polarized light and a second polarized light orthogonal to the first polarized light,
an optical-path-length-difference imparter that imparts a predetermined optical-path-length difference between the first polarized light and the second polarized light, and
a second polarizing beam splitter that forms the pulsed light the repetition frequency of which is changed by combining the first polarized light and the second polarized light after impartation of the predetermined optical-path-length difference, and
wherein the switcher changes the polarization direction of the pulsed light incident on the first polarizing beam splitter to either the first direction or a second direction different from the first direction,
wherein a single polarizing beam splitter is used as the first polarizing beam splitter and the second polarizing beam splitter,
wherein a first quarter-wave plate is installed in an optical path of the P-polarized light, and a second quarter-wave plate is installed in an optical path of the S-polarized light,
wherein, in a process of imparting the predetermined optical-path-length difference, the P-polarized light passes through the first quarter-wave plate twice, and the S-polarized light passes through the second quarter-wave plate twice, and
wherein, a position at which the P-polarized light passes through the first quarter-wave plate in each of the n units of the optical units differs from that in other of the n units of the optical units, and a position at which the S-polarized light passes through the second quarter-wave plate in each of the n units of the optical units differs from that in other of the n units of the optical units.

47. The optical device according to claim 45,
wherein the switcher has a half-wave plate provided on an optical path along which the pulsed light is incident on the first polarizing beam splitter.

48. The optical device according to claim 47,
wherein, when an angle formed by the polarization direction of the pulsed light incident on the half-wave plate and a slow axis or a fast axis of the half-wave plate falls within a first angular range, the pulsed light in the first direction is emitted from the half-wave plate, and when the angle falls within a second angular range different from the first angular range, the pulsed light in the second direction is emitted from the half-wave plate, and
wherein a change to either a factor of 1 or a value of n is performed by switching between a first state, in which the angle formed falls within the first angular range, and a second state, in which the angle formed falls within the second angular range.

49. The optical device according to claim 48,
wherein the half-wave plate is rotatable, and
wherein the angle formed is changed by rotation of the half-wave plate.

50. The optical device according to claim 48,
wherein the first angular range is a range of) (22.5°±K×45°±1° (where K is an integer).

51. The optical device according to claim 48,
wherein the second angular range is a range of) (0°±K×90°±1° (where K is an integer).

52. The optical device according to claim 45,
wherein given that a repetition period of the pulsed light emitted from the light source is Tr, when the predetermined optical-path-length difference is imparted by the optical-path-length-difference imparter, a time difference of Tr/2ⁿ is imparted between the first polarized light and the second polarized light.

53. A microscope that emits the pulsed light to an observation object, comprising
the optical device according to claim 45 that converts the repetition frequency of the pulsed light, and
a light emitter that emits the pulsed light, output from the optical device, to an observation object.

54. The microscope according to claim 53, comprising
a controller that controls the switcher.

55. The microscope according to claim 54,
wherein the switcher has a half-wave plate provided on an optical path along which the pulsed light is incident on the first polarizing beam splitter, and
wherein the controller controls rotation of the half-wave plate.

56. The microscope according to claim 54, further comprising
a setter that sets information corresponding to a multiplication factor of the repetition frequency by a user operation,
wherein, when information corresponding to the multiplication factor is set, the setter transmits to the controller the information corresponding to the multiplication factor that has been set, and
wherein the controller causes the switcher to change the repetition frequency based on information corresponding to the multiplication factor transmitted from the setter.

57. The microscope according to claim 53,
wherein the optical device is configured to be removably inserted in the microscope.
